(19) United States
(12) Patent Application Publication
(10) Pub. No.: US 2012/0305605 A1
(43) Pub. Date: Dec. 6, 2012

(54) PUMP AND APPLIANCES CONTAINING A PUMP

(75) Inventors: Mario E. Vassaux, Scottsdale, AZ (US); Paul Van Den Hoonaard, Peachtree City, GA (US)

(73) Assignee: INTELLIGENT COFFEE COMPANY, LLC, Scottsdale, AZ (US)

(21) Appl. No.: 13/516,468

(22) PCT Filed: Dec. 16, 2010
(86) PCT No.: PCT/US10/60776

§ 371 Date: Aug. 23, 2012

Related U.S. Application Data
(60) Provisional application No. 61/286,973, filed on Dec. 16, 2009.
(60) Provisional application No. 61/322,657, filed on Apr. 9, 2010.

(51) Int. Cl. B65D 83/00; B21D 51/16; F16K 31/02

(52) U.S. Cl. 222/325; 251/129.01; 29/890.09

(57) ABSTRACT

A cartridge for dispensing a stock liquid is provided. The cartridge includes a hollow body and a pump. A liquid dispenser suitable for numerous applications, having a removably insertable cartridge and methods of dispensing a liquid are also provided. Appliances including a removably insertable cartridge and methods of dispensing a liquid are also provided.

### CROSS REFERENCE TO RELATED APPLICATIONS

This application claims the benefit of U.S. provisional Appln. No. 61/322,657 filed Apr. 9, 2010 and U.S. provisional Appln. No. 61/286,973 filed Dec. 16, 2010, both of which are incorporated herein by reference as if fully set forth.

### BACKGROUND

Consumable products, for example, baby formulas, detergents, and medicines, are often cumbersome to mix and/or dispense in proper amounts, and require appreciable amounts of storage space.

Beverage dispensers are known for making a beverage from a liquid concentrate/extract. In one known prior art reference, a pressurized liquid canister of liquid beverage concentrate/extract is placed within a pitcher-shaped device having a mechanism for releasing a predetermined amount of liquid concentrate/extract from the pressurized canister into a beverage mixing chamber. A heated liquid reservoir is located at the bottom of the vessel and heated liquid is also forced upwardly into the mixing chamber where the mixed beverage is formed in the device prior to being poured. This device has several drawbacks due to the complex nature of the dispensing mechanism and the need to clean out the mixing chamber in the device after each use. It is also known to provide a coffee machine for use with shelf-stable liquid coffee concentrate/extract. The liquid coffee concentrate/extract is poured into a reservoir in the coffee maker and a predetermined amount of the concentrate/extract is moved from the reservoir to the brewing chamber, where it is mixed with heated water prior to being dispensed into a carafe.

Known dispensers often dispense a stream of concentrate/extract and water which is not adequately mixed, and complete mixing does not take place until the fluids enter a user's cup. An unmixed stream of concentrate/extract and water dispensed by a beverage dispenser is sometimes identified by the trade term “striping” or as the “zebra effect”.

It has also been suggested to provide a beverage system for brewing a beverage from a dry beverage material and a source of hot, pressurized water. The beverage material is provided in a sealed cartridge and the dispenser pierces the sealed cartridge and injects hot, pressurized water into the cartridge to brew the beverage from the beverage material. A carousel device may be provided, which allows a user to select from one of several different beverage cartridges. However, a drawback of this device is that residue from a previous beverage will remain in the hot, pressurized water-injecting area as well as in the downstream collection funnel, which directs the beverage into a user's cup. Further, in the case of typical beverage systems of this type for producing hot coffee drinks, dry coffee material including instant, non-brewed coffee product is provided. Such non-brewed coffee product typically produces coffee beverages which to at least some extent lack the distinct flavor of brewed coffee.

### SUMMARY

In an aspect, the invention relates to an appliance including a dispenser for a liquid. The appliance may be selected from but is not limited to a drink maker, a coffee maker, a refrigerator, a water cooler, a dish washer, a washing machine, a baby formula dispenser or a medicine dispenser. The appliance includes a housing including a dispensing area for dispensing a fluid; a cartridge receiving area in the housing; an electromagnetic dispensing actuator located in the housing; a cartridge removably insertable into the cartridge receiving area in a position to be actuated by the dispensing actuator, the cartridge adapted to hold a stock liquid to be dispensed into the dispensing area after placement into the cartridge receiving area. The cartridge includes a hollow body; a pump having a pump body connected to the hollow body; a metal body including a ferromagnetic material located in the pump body; and an orifice in the pump body. The appliance also includes a controller located in the housing to control the actuator to discharge stock liquid from the cartridge.

In an aspect, the invention relates to a cartridge for a fluid dispenser. The cartridge includes a hollow body adapted to contain a stock liquid; a pump having a pump body connected to the hollow body; a metal body including a ferromagnetic material located in the pump body; and an orifice in the pump body.

In an aspect, the invention relates to a fluid dose-measuring device adapted to be releasably received in a dispensing apparatus having an electromagnetic coil. The device comprises a housing with an outlet passage and a connector part defining an inlet passage, wherein said housing forms an internal chamber which is in fluid communication with the inlet passage and the outlet passage. Inside the chamber, a piston is moveably arranged for reciprocating motion. The inlet is connectable to a fluid container.

### BRIEF DESCRIPTION OF THE DRAWINGS

The preferred embodiments of the present invention are described below with reference to the drawing figures where like numerals represent like elements throughout.

FIG. 1 is a cross-sectional view of a concentrate/extract cartridge in a liquid dispenser.

FIG. 2 is a left side perspective view of a beverage dispenser of FIG. 1.

FIG. 3 is a perspective view of the dispenser with the access door for the concentrate/extract cartridge opened for insertion or removal of the cartridge.

FIG. 4 is a front elevation view of the dispenser of FIG. 1.

FIG. 5 is a right side perspective view of the beverage dispenser of FIG. 5 with the housing removed.

FIG. 6 is a front elevational view of the beverage dispenser of FIG. 5 with the housing removed.

FIG. 7 is top plan view of the beverage dispenser of FIG. 5 with the housing removed.

FIG. 8 is a left side elevational view of the beverage dispenser of FIG. 5 with the housing removed.

FIGS. 9a-c illustrate cross-sectional views of a pump. In FIG. 9a, the plunger assembly is down and the pump is closed. In FIG. 9b, the plunger assembly is going up, the blue valve opens to move plunger assembly up through the liquid. In FIG. 9c, the plunger assembly is moving down dispensing liquid from the orifice, the valve is closed, and while the plunger is pushing stock liquid down, it is pulling new stock liquid from a stock liquid source.

FIG. 10 is a cross-sectional view of a pump.

FIG. 11 is a bottom view of a pump.

FIG. 12 is an exploded view of a pump.

FIG. 13 is a cross sectional view of a cartridge being assembled by inserting a pump into the socket in the cartridge.

FIG. 14 is a perspective view of a dispensing assembly according to an embodiment with a loading door in an open position, and the cartridge in a cartridge receiving area.

FIG. 15 is an enlarged perspective view of a portion of the cartridge receiving area of FIG. 14 showing the pump inserted in the activator body.

FIGS. 16-18 are left side perspective views of a dispensing assembly incorporated in a dishwasher.

FIGS. 19-21 are perspective views of a plurality of dispensing assemblies incorporated into a clothes washer.

FIGS. 22-23 are perspective views of a dispensing assembly incorporated into a medicine dispenser.

FIGS. 24-25 are perspective views of a dispensing assembly incorporated into a bottle-fed beverage dispenser.

FIG. 26 is a perspective view of a liquid dispenser with a cartridge incorporated into a refrigerator.

FIG. 27 is a top plan view of a cartridge carousel included with the home appliance of FIG. 26.

FIG. 28 is a partial front elevational view of the home appliance of FIG. 26.

FIGS. 29-30 are perspective views of a dispensing assembly incorporated into a bottle-fed beverage dispenser.

FIG. 31 shows a fluid dose-measuring device in a partial cut-away view.

FIG. 32 shows a dispensing system.

FIG. 33 shows the device of FIG. 31 in exploded view.

FIG. 34A-34D show schematically in transparent view the working principle of the device of FIG. 31.

FIG. 35A-35C show schematically in combination a dose-measuring device and a fluid container.

FIG. 36A-36C show schematically in combination a dose-measuring device and a fluid container.

FIG. 37A-37B show in cross sectional view a dose-measuring device.

### DETAILED DESCRIPTION OF EMBODIMENTS

Certain terminology is used in the following description for convenience only and is not considered limiting. Words such as “front”, “back”, “top” and “bottom” designate directions in the drawings to which reference is made. Additionally, the terms “a” and “one” are defined as including one or more of the referenced item unless specifically noted. The phrase “at least one” followed by a list of two or more items, such as “A, B, or C,” means any individual one of A, B or C as well as any combination thereof.

In an embodiment, a pump is provided which allows for the dispensing stock liquid. The stock liquid may be but is not limited to a liquid concentrate/extract.

In an embodiment, a system is provided including a pump to dispense liquid products. The pump may be configured to dispense stock liquid. The stock liquid may be but is not limited to a liquid concentrate/extract. The stock liquid may be a liquid product that will be dispensed without mixing. The liquid product may be but is not limited to the stock liquid, or a mixture of the stock liquid and a diluent.

A system may be configured to dispense liquid products in a manageable and convenient manner for a number of different applications. A system may be configured to allow a user to select a concentration or strength of a liquid product made from a stock liquid and a diluent. A user may be provided a number of different selections so that a specific need or preference can be satisfied.

An embodiment provides a dispenser that allows a user to dispense an exact desired amount of liquid product and that does not waste excess stock liquid in the user container or in the dispenser itself. In an embodiment, a user can select from multiple product types and to select from multiple container sizes, while still providing a liquid product at a desired strength.

In an embodiment, a system is provided that includes a dispenser which dispenses a mixture of stock liquid and water or other diluent which is well-mixed and homogeneous prior to entering a container.

Embodiments relate to a stock liquid cartridge including a hollow body and a pump. The stock liquid cartridge may be included with a dispenser, which may dispense liquid from the stock liquid cartridge. The stock liquid cartridge may be included with a dispenser, which may dispense a diluent and liquid from the stock liquid cartridge. The cartridge may be included with a beverage dispenser. Embodiments also relate to the pump.

An embodiment includes a dispensing system that can be utilized in a number of different dispensing applications. The applications may be those that include a diluent or those that do not include diluent.

Another embodiment relates to dispensing systems which dispense fluids in an exact metered fashion. Dispensing systems herein may be used by consumers for completing a variety of tasks, which may provide an increased efficiency.

A more convenient and easy system to mix and dispense multiple types of products, including but not limited to detergents, medicines, baby foods, and beverages, from a single dispenser in a convenient and user friendly manner is provided. The system may be provided in a manner that does not require cleaning the dispenser when a user wishes to change the type of beverage being dispensed. The system may be provided in a manner to allow a user to select a beverage strength from a number of different selections so that a user preference can be satisfied. The system may be provided in a manner to allow a user to select from multiple beverage types and to select from multiple beverage container sizes, such as coffee mugs or disposable cups having different sizes while still providing the beverage at a desired strength.

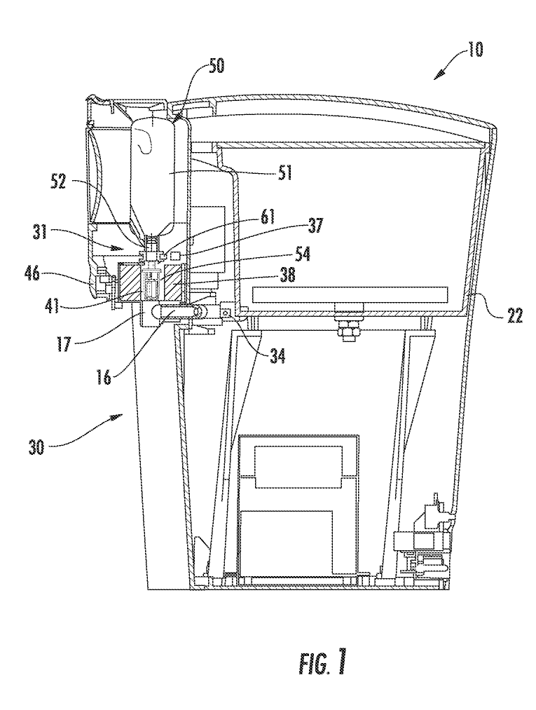

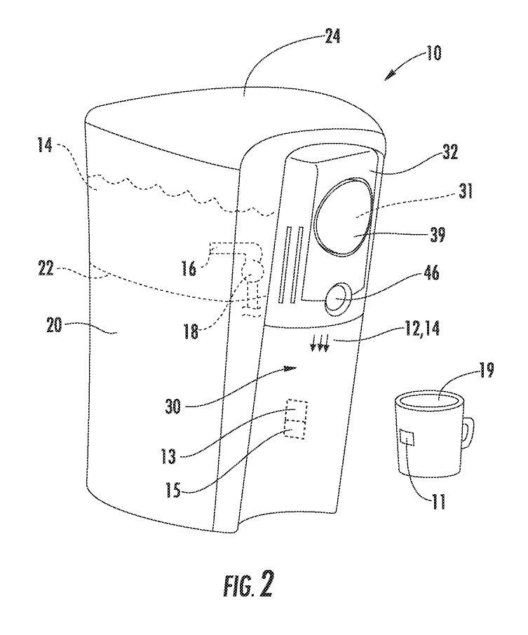

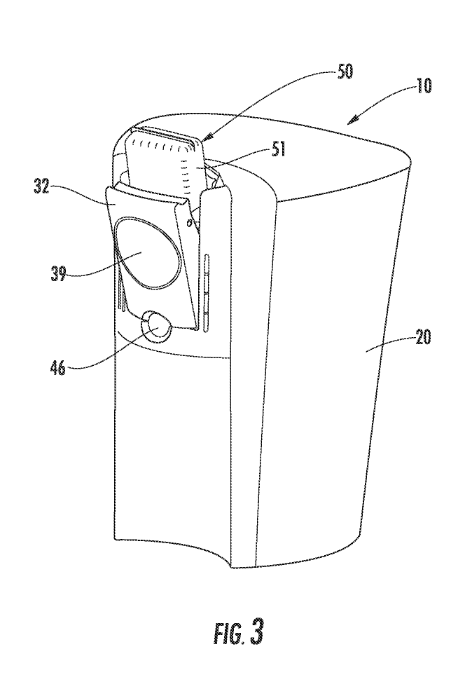

A system including a coffee maker dispenser is described as a non-limiting example. FIGS. 1-4, show a beverage dispenser 10 for use with a cartridge 50, adapted to dispense a beverage comprising a liquid extract (the stock liquid, which is designated by arrows 12 in a dispensing area 30 in FIG. 2 and may be a liquid concentrate/extract) and a diluent 14 (in a reservoir 22 and designated by arrows 14 in FIG. 2). Dispensers, pumps and methods of actuating and controlling a dispenser are described in U.S. application Ser. No. 11/055,915, which was filed Feb. 11, 2005 and issued as U.S. Pat. No. 7,614,524 on Nov. 10, 2009; U.S. application Ser. No. 11/055,832, which was filed Feb. 11, 2005 and issued as U.S. Pat. No. 7,594,525 on Sep. 29, 2009; U.S. application Ser. No. 12/569,066, which was filed Sep. 29, 2009; U.S. application Ser. No. 11/266,695, which was filed Nov. 3, 2005 and issued as U.S. Pat. No. 7,651,015 on Jan. 26, 2010; U.S. application Ser. No. 12/114,050, which was filed May 2, 2008; and U.S. application Ser. No. 11/926,931, which was filed Oct. 29, 2007, which are incorporated herein in by reference as if fully set forth. The devices and methods therein may be adapted for use with an embodiment of a pump herein, which may be pump 41, any other pump herein, a cartridge herein, a fluid dose-measuring device herein, or a similar pump. For use with warm beverages the diluent reservoir 22 may be heated by a heating element. For use with cool beverages the diluent reservoir 22 may be cooled by a cooling element.

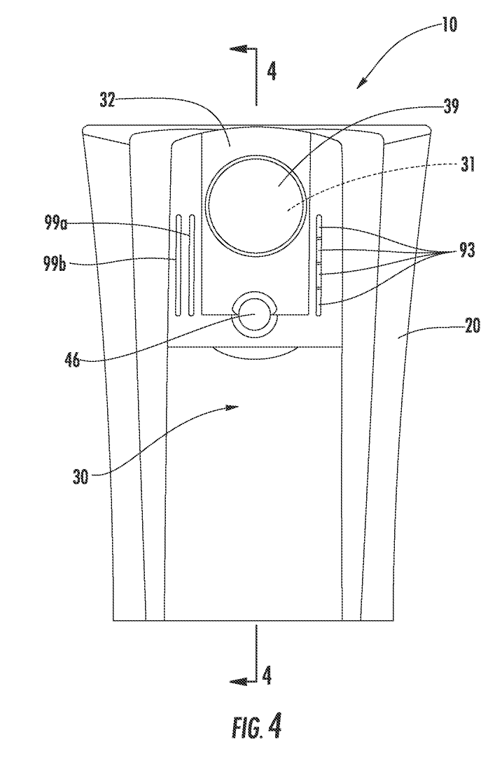

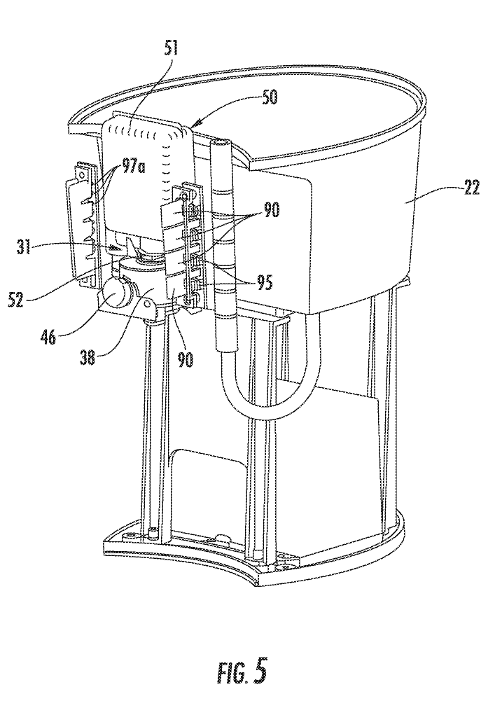

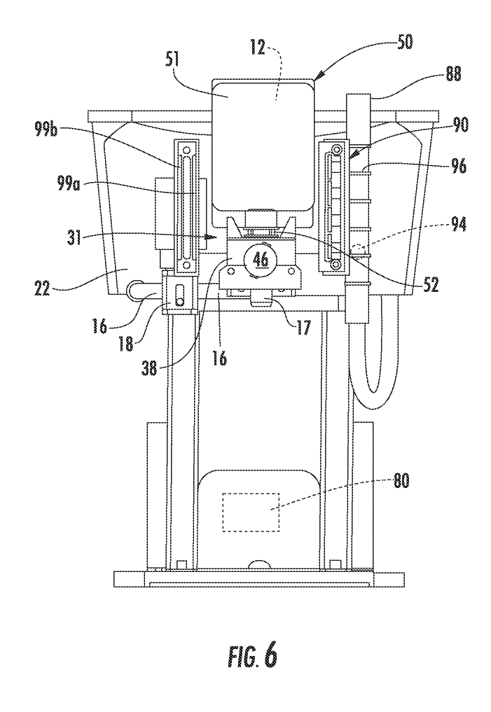

As shown in FIGS. 1, 2 and 6, preferably a reservoir supply line 16 is connected to the reservoir 22 and delivers the diluent 14 to the dispensing area. The supply line 16 is preferably connected to a control valve 18 that can dispense water from the reservoir to the dispensing area at varying rates. The control valve 18 is preferably a solenoid driven pinch valve, as shown; however, any suitable control valve can be used. Alternatively, the supply line 16 could be connected to a pump for emptying diluent 14 from the reservoir 22. As shown in FIGS. 5-7, a level sensor 88 may be connected to the reservoir 22, which can be used by a controller 80 to determine diluent flow rate information. The level sensor 88 can be a float 94 arrangement that either provides the level information directly, for example by a lever attached to the float 94, or indirectly, such as by the float 94 being magnetic and tripping magnetic switches set at different levels on the outside of the reservoir 22, or by any other suitable means. This information is preferably used by the controller 80 to adjust a rate of actuation of a dispensing actuator 38, as described below, to dispense a desired amount of concentrate/extract 12 relative to an amount of dispensed diluent 14. Alternatively, based on the diluent flow rate information received, the controller 80 can control the control valve 18, or alternatively a diluent discharge pump, permitting discharge of an appropriate amount of diluent 14 relative to an amount of dispensed extract 12. As an alternative to the level sensor, a flow rate sensor could be provided in the supply line 16 in order to measure flow rate information.

As shown in FIGS. 1 and 5-7, the cartridge 50 includes a hollow body 51 (also referred to as a fluid container with respect to FIGS. 31-37b) for containing the stock liquid 12, which may be a concentrate or extract. The hollow body 51 may be collapsible and fabricated from a flexible laminate sheet including layers of one or more of polyethylene, polyester, and metallic foil. Alternatively, other suitable materials can be used to create the flexible laminate sheet. A spout connector 52 is preferably sealably connected to the hollow body 51. An inner layer of the hollow body 51 preferably includes features, such as sealing areas, which contact and align with cooperating features on the connector 52. During assembly, heat and pressure could be applied for a predetermined period of time to the area where the hollow body 51 and the connector 52 are in contact, sealably connecting the hollow body 51 to the connector 52. The inner layer of the hollow body 51 and the connector 52 may be made of the same material, for example polyethylene, or otherwise made of compatible materials, so that when heat and/or pressure are applied, the hollow body 51 and connector 52 are sealed together. Alternatively, the connector 52 can be adhered to the hollow body 51 using any suitable adhesive and/or adhering method. In other alternatives, the hollow body is not collapsible or flexible.

A pump, such as the pump 41 in FIG. 1, may be connected to the spout connector 52. The pump device is preferably adhered or mechanically fastened to the spout connector 52. Alternatively, the pump 41 can be integrally formed with the spout connector 52.

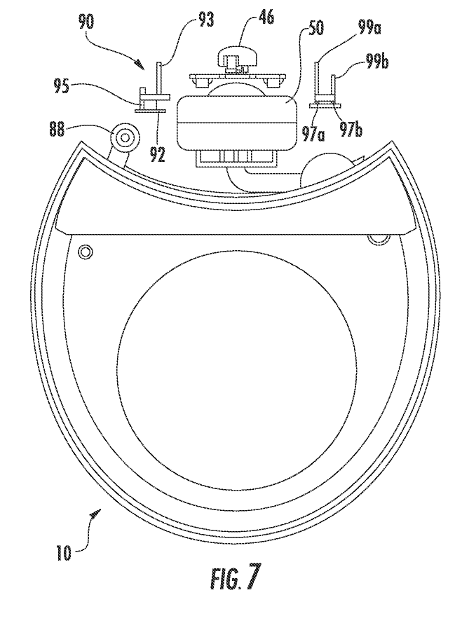

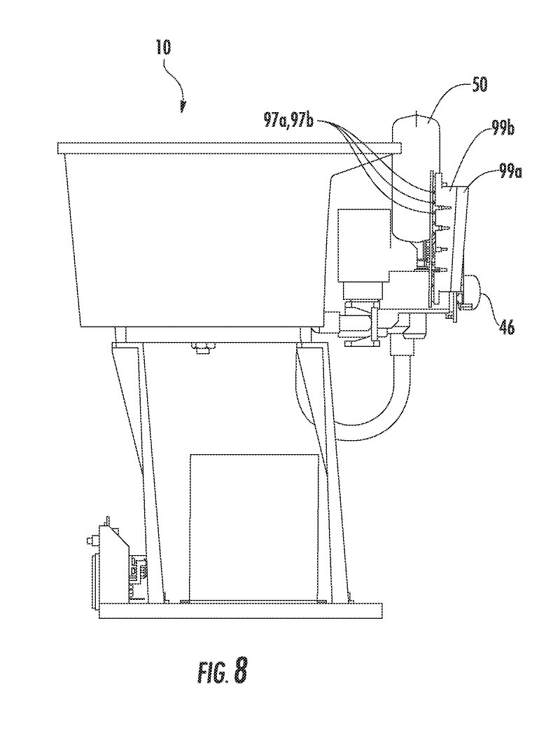

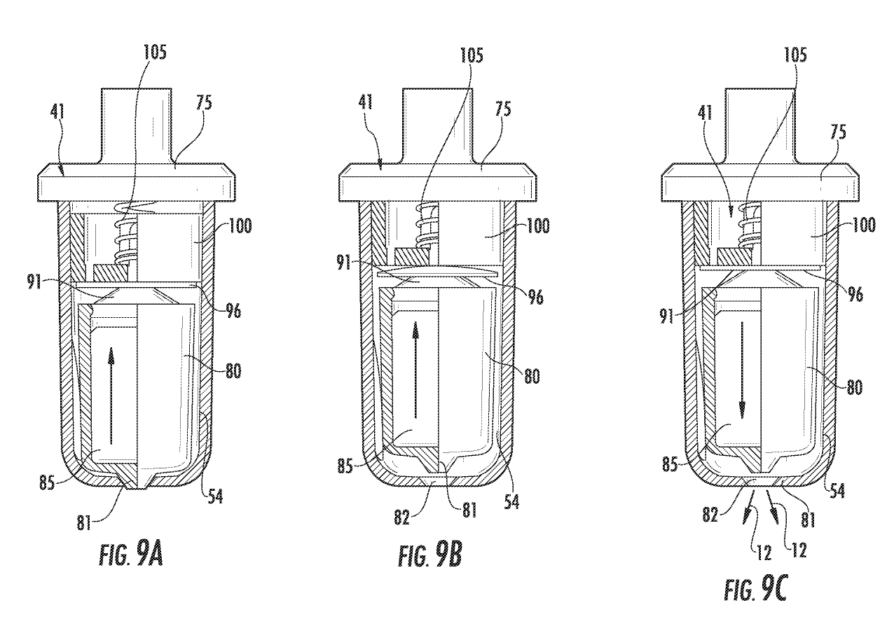

Referring to the FIGS. 9a-c and 10-12, a first embodiment of the pump 41 is shown in detail and includes a pump body 54 connected to a probe 75. The pump body 54 may be axially resilient. The probe 75 may provide a connection to the spout connector 52. The pump body 54 may be fabricated from a single piece or multiple pieces connected together. Stock liquid (shown as arrows 12 in FIG. 9c), which may be a liquid concentrate/extract, may pass from the hollow body 51 into the pump body 54. A plunger 80 is inside pump body 54 and a metal body 85 is the inside plunger 80. The metal body may include or be entirely made of a material having a metal. The metal body 85 may include a ferromagnetic material. The plunger may be non-metal or coated with a non-metal material. The non-metal may be but is not limited to a plastic, a rubber, or a thermoplastic elastomer (TPE). A valve 96 is disposed above the plug 91 and is associated with the valve seat 100. The top of the plug 91 extends through the valve 95 into valve seat 100 and engages a spring 105, which is associated with the probe 75. The probe 75 is connected to the spout connector 52. A seal 110 is positioned near the top of the probe to facilitate a seal between the pump and the hollow body 51. The seal may be an o-ring. The plunger 80 includes a shut off tip 81 that may be positioned in an orifice 82 in the pump body 54.

One or more surfaces of the pump that contact the stock liquid 12 may be non-metal or coated with a non-metal material. The spring 105 may be stainless steel, non-metal, or coated with a non-metal. The non-metal may be but is not limited to a plastic, a rubber, or a thermoplastic elastomer (TPE).

As set for the above, the pump 41 is connected to the hollow body 51 through the spout connector 52. In another embodiment, the hollow body 51 may be connected to the pump 41 by any other suitable adhesive or sealing method. In another embodiment, the pump 41 and hollow body 51 are integral with one another.

In an embodiment, a pump 41 may be provided to reduce clogging or contamination. When the pump 41 is not activated, the plunger tip 81 may be forced forward by the spring 105 closing the orifice hole 82. This may keep liquid from coming out and seal the contents of the pump and pouch from air, which may prevent clogging and contamination.

In an embodiment, the metal cylinder 85 is coated with a non-metal material, which may be but is not limited to a plastic, a rubber, or a thermoplastic elastomer (TPE). The metal cylinder 85 or the coating on it may take the place of one or more of the plunger 80, shut off tip 81, and plug 90.

In a preferred embodiment, a pump above may be configured to provide the following features: Metal is not in contact with fluid; and fluids are not in contact with the metal part due, in some embodiments, to metal being fully encapsulated inside plastic. Cleaning of the pump may be enhanced since there may be provided a reduced cavity or no cavity within the pump. Also surface area may be reduced so that product build-up is reduced, which could reduce “glue shut” of the pump. The pump can be shut-off is at the very end of the pump body through insertion of the shut off tip in the orifice. This may allow flushing the tip of the pump clean at the end of every dispensing cycle. In the event that a pump does get stuck, the end user may be able to simply push on the tip to loosen the moving parts in the pump. The plunger-valve assembly may be allowed only to make a fixed stroke, which is expected to contribute to improved consistency of the pump output. Final adjustment of stroke length; e.g., by modifying the height of the valve seat, could be used to dial-in desired output. A pump may be closed tighter when pouch is pressurized since the plunger could be pushed forward by the spring in closed position, and squeezing or pressuring the pouch will only increase the seal. The shut-off at the very end of the pump may be configured to protrude slightly through the orifice in the pump body. In a preferred embodiment, the pump design suitable for many different liquids. In an embodiment, the pump design is suitable for low viscous liquid products having 1-10 centiPoise (similar to Esio concentrates).

Referring to FIGS. 1 and 5-6, a dispensing actuator 38 is fixed within the cartridge receiving area 31 and includes an opening 40 for receiving the pump 41 of the cartridge 50 therein. The dispensing actuator 38 also includes an electromagnet 76 which preferably comprises a wound coil or solenoid arrangement. The wound coil or solenoid can include one or more focusing rings located inside the coil to focus the magnetic flux generated.

In an embodiment for use with the cartridge 50, a sliding ferromagnetic sleeve 58 is aligned with the electromagnet 76. The ferromagnetic sleeve 58 may be concentrically aligned with electromagnet 76. Preferably, a ferromagnetic stop member 59 is connected to the dispensing actuator 38 limiting the motion of the sliding sleeve 58 and channeling magnetic flux produced by the electromagnet 76. The ferromagnetic sleeve 58 includes a circumferential protrusion 62. When the cartridge 50 is in an installed position in the receiving area 31, bearing members 66 on the center portion of the resilient tube contact the circumferential protrusion 62 of the sliding ferromagnetic sleeve 58.

The electromagnet 76 receives current, such as alternating or direct current, from the controller 80. In a preferred embodiment, the controller 80 intermittently provides 24 volts over the coil to produce an intermittent direct current which induces an intermittent magnetic field.

The cartridge 50 dispenses the stock liquid 12 as follows. Current is induced in the wound coil by an applied voltage, preferably 24 volts over the electromagnet 76 as provided by the controller. Alternatively, the controller can provide other suitable voltages for producing alternating or direct current. The application of voltage causes the metal body 85 to be drawn from the position shown in FIG. 9a toward the electromagnetic center of the electromagnet 76 as shown in FIG. 9b. The plunger 80 follows in an upward motion with the metal body 85, displacing the shut off tip 85 and valve 95, as shown in FIG. 9b. During the upward motion of the ferromagnetic sleeve 58, stock liquid is forced through the port 83 and into the into the area around and beneath plunger 80. Next, the controller cuts off voltage to the actuator 38, allowing the ferromagnetic sleeve 58 to move downwardly away from the stop member 59 by force of the spring 105 and/or gravity, forcing stock liquid out of orifice 81. At the same time, stock liquid 12 from the hollow body 51 is drawn into the area above plunger 80. The hollow body 51 is preferably collapsible and collapses to facilitate the extraction of stock fluid 12 from the hollow body. A voltage, such as the preferred 24V DC producing voltage, or other suitable AC or DC producing voltage, is cycled on and off to provide an intermittent current for repeating the above-described process continuously until a desired amount of the stock liquid 12 is dispensed. Alternatively, other types of actuators can be used to act on the metal body 85.

An improved dose-measuring device, which may be more economical to manufacture, and may have an increased design freedom is provided in embodiments herein.

An embodiment provides a fluid dose-measuring device adapted to be releasably received in a dispensing apparatus having an electromagnetic coil, comprising:
a housing with an outlet passage and a connector part defining an inlet passage, said housing forming an internal chamber which is in fluid communication with the inlet passage and the outlet passage, and said connector part being connectable to a fluid container;
a piston moveably arranged in the chamber of the housing for reciprocating motion between a closed position in which a flow from the inlet passage to the outlet passage is prevented and an open position in which a flow from the inlet passage to the outlet passage is allowed, said piston comprising a ferromagnetic actuation part for electromagnetic actuation of the piston by the electromagnetic coil,
wherein the actuation part is arranged in an outer body.

An advantage is that ferromagnetic material allows electromagnetic actuation of the actuation part. Also, the outer body may be provided with a material that is inert with respect to the fluid being delivered. In addition, the ferromagnetic actuation part and/or outer body may be fabricated such that the actuation part smoothly reciprocates within the housing. As a result, more materials may be suitable for the outer body, so that a suitable material with a simple manufacturing process can be chosen. Further, the actuation part can be made simpler as there is no need for a protective coating on the surface of the ferromagnetic actuation part. As a consequence, the overall manufacturing of the device is more economical.

Another advantage may be that the outer body is able to protect the ferromagnetic material in a more efficient way. Protective coatings applied to the ferromagnetic actuation part of the piston may not always result in an efficient protection as the coating processes and could leave some small areas uncovered. This may result in undesired contact between ferromagnetic material and the fluid to be dispensed. Applying a protective coating is possible in some embodiments, but embodiments herein also provide an alternative to the coating material.

A further advantage may be that the design freedom of the piston has increased with respect to material choice and associated fabrication possibilities, thereby also allowing a more complex design at relatively low cost. Further, the actuation part can be made in a universal design, and the differences in design of the piston can be formed in the outer body, so that the actuation part is the same for every device type and thus the actuation behaviour is similar, thereby allowing a uniform actuation scheme.

In an embodiment, fluid is able to pass through the piston via at least one internal passage, and at least part of sidewalls of the piston are in full, possibly sealing, engagement with a sidewall, i.e. peripheral wall, of the housing. In a minimum requirement the outer body only needs to be provided at areas where there may be contact between the actuation part and the fluid inside the chamber, so possibly not between the actuation part and the sidewall of the housing or not entirely. The body may comprise a seal between the piston and the sidewall of the housing to prevent fluid from entering a space between the actuation part and the sidewall of the housing.

In an embodiment, the actuation part is encapsulated by the outer body. An advantage over a partially covered actuation part, is that it simplifies the design and fabrication as no seals are required and thus also the tolerances may be less tight. Also the chance of leakages due to wear and damages are smaller.

The outer body may be made of a non-metallic material. The non-metallic material may be a plastic. This allows the body to be injection-moulded and also ensures that the body is compatible with a wide variety of fluids, especially fluids used in the food and pharmaceutical industry. It also allows a magnetic field to penetrate the outer body to interact with the ferromagnetic material of the actuation part.

In an embodiment, the piston in the closed position sealingly engages with the outlet passage, preferably from the chamber side of the outlet passage, i.e. the piston does not protrude through the outlet passage and therefore does not engage with the outlet passage from the outside of the housing. This has the advantage that pressure inside the container, e.g. due to squeezing the container, will firmly keep the piston in the closed position, so that the chance of leaking of the device during handling is minimized.

The housing may include a peripheral wall, a bottom wall, and a top wall. The peripheral wall being located between the bottom wall and the top wall. The connector part is attached to the top wall, so that the inlet passage extends from the top wall to a free end of the connector. The outlet passage is situated in the bottom wall. The housing may only allow the escape and entering of fluid via the inlet passage and the outlet passage, i.e. no other passages or openings would be provided in the housing. Further, the walls of the housing and the connector part may be rigid.

The peripheral wall may form a tubular housing closed at its end by the bottom wall and top wall. One of the inlet or outlet passage or both passages are aligned with a longitudinal axis of the tubular housing. This will ensure a more symmetric flow pattern through the chamber.

In an embodiment, the outer body comprises at least one internal passage to allow a fluid flow from the inlet side of the piston to the outlet side of the piston. The outer body may have one or more valves, which may be non-return valves, which may be integrated in the internal passage allowing fluid to flow only from the inlet side of the piston to the outlet side of the piston. The device is then able to function as a pump with the advantage that the dispensed flow rate is now dependent on the frequency of reciprocations and the stroke of the piston inside the housing. As a result, the dispensed amount is much more predictable with respect to dispensed amounts being dependent on gravity and/or pressure inside the container. The dispensed amount per cycle, i.e. per a single reciprocation, thus depends on the stroke of the piston which can be set by appropriately energizing the electromagnetic coil and the design of the housing. By changing the design of the housing, for instance by providing a longer chamber inside the housing, the maximum stroke of the piston can be changed. Alternatively, the stroke can be adjusted by appropriately energizing the electromagnetic coil, with the maximum stroke as an upper limit.

It is noted that the ability to integrate the non-return valves in the outer body is at least partially a result of the increased design freedom of the piston obtained by a device according to the invention over prior art devices.

In case the body is made of plastic, the one or more non-return valves can be injection-moulded integrally with the outer body at the same time in a simple manner.

In an embodiment, the outer body is composed of two parts which in assembled state confine, i.e. retain, the actuation part. The two parts may retain the actuation part by encapsulating it. The two parts may therefore define a cavity in which the actuation part is placed, i.e. received. By dividing the outer body in two parts, the actuation part may be fairly easy introduced into the cavity, after which the cavity is closed off to prevent fluid from entering the cavity. One of the outer body parts may have a cup shape to form the cavity, and the other outer body part may close off the cavity, e.g. in the form of a plug introduced into the cavity. The two parts may be made of different materials, e.g. different plastics, for instance, one part may be made of TPE, i.e. thermoplastic elastomer, and the other part may be made of acetal, i.e. polyoxymethylene plastic, also known as polyacetal or polyformaldehyde.

In an embodiment, the one or more non-return valves are integrated in one of the two parts of the outer body and the other part comprises associated valve seats for the one or more non-return valves. However, an embodiment wherein one of the two parts comprises the valves and associated valve seats is also possible. It is envisaged that only one part has an internal passage. In that case, fluid flows through one part and passes the other part on the outside of said part. Also an embodiment in which each part has an internal passage is possible. From a manufacturing point of view it may be advantageous to design only one part with an internal passage as this makes it easier to manufacture the integrated non-return valves. Manufacturing integrated non-return valves inside a passage is more difficult than manufacturing them at the end of an internal passage.

In an embodiment, the piston is moveable in a direction from the inlet passage to the outlet passage and vice versa, so that the piston is able to alternatingly move from and towards the outlet passage and force the fluid through the outlet passage when moving towards the outlet passage. Alternatively, the piston can move perpendicular to the direction from the inlet passage to the outlet passage and vice versa, which is an embodiment that is particularly suitable for a device that functions as a valve.

In an embodiment, the housing is composed of two parts. Each part may include one of the inlet and outlet passage. The part comprising the outlet passage may be formed by the peripheral wall and the bottom wall, and the part comprising the inlet passage may be formed by the top wall and the connector part. The part comprising the outlet passage then also has a cup shape with a cavity in which the piston can be placed.

In an embodiment, the piston is spring loaded by a spring element, e.g. a coil spring and/or compression spring, tending to move the piston towards the closed position. This ensures that after deenergizing of an electromagnetic coil, the piston is automatically moved back to its closed position. Moving back to its closed position may also be done with the aid of pressure inside the container, gravity, or by energizing the coil in an appropriate manner. The spring element may keep the piston in the closed position when the coil is deenergized, so that the closed position is not or less dependent of gravity. This has the advantage that the device with fluid container can be held upside down without the risk of leakage of the device, assuming that the spring is able to counteract gravitational forces on the piston.

The spring element may extend from the piston into the inlet passage, i.e. into the connector part. The spring element may extend over more than half the length of the connector part.

An advantage is that the spring element can now be designed to be lengthy in the inlet passage. A longer design has the advantage that the fabrication tolerances are less critical, and the spring element is easier to handle during assembly. Further, the total length of the device may not be affected by the longer spring element.

To further increase the length of the spring element, the spring element may also extend into the piston. The piston may therefore be provided with a cavity or recess in which the spring element can be received.

In an embodiment, the piston comprises a stem that may extend into the connector part, and the spring element is provided around the stem. When the stem has a sufficient length it prevents the spring element from buckling. At least the stem is able to hold one end of the spring element. The spring element is preferably a coil spring, so that the stem can be received inside the windings of the coil spring. The length of the spring element is larger than the length of the stem to allow the piston to reciprocate inside the chamber without the stem damaging and/or touching the interior of the connector part, i.e. the inlet passage.

In an embodiment, the outer body comprises a protrusion that sealingly engages with the outlet passage in the closed position to prevent fluid from flowing through the outlet passage. The protrusion may extend into the outlet passage in the closed position.

In an embodiment, the protrusion and the outlet passage have respective sealing surfaces engaging with one another in the closed position, wherein the sealing surface of the outlet passage extends substantially to the exterior surface of the housing, e.g. the bottom surface of the housing when the outlet passage is situated in the bottom wall. In this manner, in the closed position, no or minimal fluid is trapped in the housing between the piston and the outlet passage which is in contact with air outside the chamber. Therefore, drying of the fluid in the closed position which may result in a clogged device is minimized or prevented at all. And even when the device gets clogged and/or the piston gets stuck in the closed position, a user or machine is able to free the outlet passage and/or release the piston via the outlet passage as the protrusion extends into the outlet passage in the closed position and is therefore reachable.

In an embodiment, the connector part is a male part to be connected to a female part of a fluid container. The female part has a body containing an axial bore which extends from an insert opening for the male part through the body, and a seat extending around the bore for a plug which serves to close off the bore. The bore of the female part forms a shoulder between the insert opening and the seat, said shoulder facing towards the insert opening. The plug is provided with at least one elastic hooking part with corresponding hooking surface, wherein the hooking part rests in a first position with its hooking surface against the shoulder, and wherein the male part has a head and a recess located behind the head for receiving the hooking part of the plug when the male part is inserted into the bore, so that the plug connects with the male part, i.e. corresponding to a first connection position. When the male part is pushed further, i.e. to a second connection position, the plug disengages from the seat allowing fluid communication. Subsequently pulling the male part back to the first connection position will result in closing of the bore by the plug again. For instance, a connector assembly according to WO 99/05446 is used. An advantage is that connecting and disconnecting the male part, i.e. the device, automatically opens and closes the fluid container without the risk of leakage. Disconnecting the dose-measuring device may be advantageous when the fluid container is used again and needs to be refilled. It is noted here that depending on the design of the device, a refill may also be done via the dose-measuring device, so that disconnecting the dose-measuring device is not essential.

Connecting the dose-measuring device to a filled fluid container may expose the content of the fluid container to air already present in the dose-measuring device. It may therefore be desired that the dose-measuring device is pre-assembled to the fluid container, but fluid communication between fluid container and dose-measuring device is blocked until the fluid container is used, i.e. will be emptied. The connection between dose-measuring device and fluid container may therefore at first be such that fluid communication is prevented, e.g. corresponding to a first position as described above, but when the fluid container including dose-measuring device is placed in a dispenser the blockage is removed automatically by an actuator, e.g. in the form of a leverage pushing the device further into the container, or by a coupling action of an operator, such as a twist or push action of the dose-measuring device relative to the fluid container, e.g. corresponding to a second position as described above. This may be combined with a tamper-evident device, showing that the content of the fluid container has not been exposed to air, not even the small amount of air that may be present in the dose-measuring device.

A tamper-evident device may also be provided at the outlet passage. A foil can cover the outlet passage from the outside so that it is visible that the device never has been used before. When installing the device in a dispensing apparatus, the tamper-evident device, i.e. the foil needs to be removed prior to installing, or the foil is penetrated in the dispensing apparatus when first placed or actuated.

An embodiment provides a method for manufacturing a dose-measuring device, any device described herein, adapted to be releasably received in a dispensing apparatus having an electromagnetic coil, comprising the following steps:
manufacturing a housing with an inlet passage and a connector part defining an inlet passage, said housing forming an internal chamber which is in fluid communication with the inlet passage and the outlet passage, and said connector part being connectable to a fluid container;
manufacturing a ferromagnetic actuation part;
manufacturing an outer body;
assembling the actuation part and the outer body to form a piston, such that the actuation part is arranged in the outer body;
assembling the piston and the housing, such that the piston is moveably arranged in the chamber for reciprocating motion.

In an embodiment, the housing is composed of two parts, each part comprising one of the inlet and outlet passage. The part comprising the outlet passage may comprise a peripheral wall and bottom wall of the housing, and the part comprising the inlet passage may comprise a top wall of the housing and the connector part. In that case, assembling the piston and the housing comprises the steps:
positioning the piston in the part comprising the outlet passage; and
assembling the part with the outlet passage and the part with the inlet passage to form the housing with the piston inside.

In an embodiment, the outer body of the piston is composed of two parts, one part having a cup shape with a cavity to receive the actuation part and the other part being configured to close of the cavity, wherein the step of assembling the actuation part and the outer body of the piston comprises the steps:
positioning the actuation part in the cavity; and
closing the cavity by assembling the two parts of the outer body.

In an embodiment, the device comprises a spring element, so that the method for fabricating the device comprises the step of introducing the spring element in the connector part of the housing before assembling the piston and the housing.

Alternatively, the piston may comprise a stem which is received in the connector part of the housing, and the spring element is put over the stem before assembling the piston and the housing.

The method may further comprise the step of providing a layer of material over the outlet passage as a tamper-evident foil.

An embodiment provides a fluid dose-measuring device is provided which is adapted to be releasably received in a dispensing apparatus having an electromagnetic coil, said device comprising:
a housing with an outlet passage and a connector part defining an inlet passage, said housing forming an internal chamber which is in fluid communication with the inlet passage and the outlet passage, and said connector part being connectable to a fluid container;
a piston moveably arranged in the chamber of the housing for reciprocating motion between a closed position in which a flow from the inlet passage to the outlet passage is prevented and an open position in which a flow from the inlet passage to the outlet passage is allowed, said piston comprising a ferromagnetic actuation part for electromagnetic actuation of the piston by the electromagnetic coil,
a spring element tending to move the piston towards the closed position, wherein the spring element extends from the piston into the inlet passage, i.e. into the connector part. Preferably, the spring element is a compression spring and/or a coil spring.

The spring element may be designed to be long. A longer design has the advantage that the fabrication tolerances are less critical, and the spring element is easier to handle during assembly. Further, the total length of the device may not be affected by the longer spring element.

The spring may bias the piston towards the closed position, so that the piston is more reliably held in the closed position than by gravity and/or pressure inside the fluid container. Gravity has the disadvantage that it only works in one direction independent of the orientation of the device, so that when the device including fluid container is held upside down, the piston may move to the open position due to gravity and the device starts to leak and/or air will enter the fluid container. Pressure has the disadvantage that it may not be a constant parameter, especially not when the fluid container is emptied, so that especially when the fluid container is almost empty, the pressure is not able to keep the piston reliably in its closed position, in particular not when the device is held upside down. A suitable spring element keeps the piston in its closed position independent of the orientation of the device.

In embodiments, the overall length of the dose-measuring device may not have to be changed due to the use of the connector part.

In an embodiment, at least half of the spring element is received in the connector part in the closed position of the piston. At least 70% of the spring element may be received in the connector part in an embodiment.

In an embodiment, at least half of the length of the connector part receives the spring element.

The internal cross sectional area of the connector part may be smaller than the external cross sectional area of the piston or the internal cross sectional area of the chamber.

In an embodiment, the piston may have a stem at the inlet side of the piston which may extend into the connector part. In that case, the spring element may be provided around the stem. Due to the presence of the stem, the spring element may be prevented from buckling and is forced into a predetermined shape or orientation, so that its behaviour is predictable. The predictable behaviour is advantageous when the spring element is used to push the piston towards the closed position when the coil is deenergized. Pushing the piston back has to be done in a certain time frame otherwise there is a risk that the coil is energized again before the piston reaches the closed position and less fluid is ejected than expected. The spring element may also extend into the piston to further increase the length of the spring element. The piston may therefore comprise a recess or cavity to receive the spring element.

It is noted here that a skilled person will understand that the force applied by the spring element on the piston can be overcome by the electromagnetic actuation of the piston using a coil to ensure proper functioning.

It is further noted that the features described in relation with the embodiments of the invention may be readily be combined in any way suitable.

The invention further relates to in combination a dose-measuring device according to the first and/or second aspect of the invention and a fluid container connectable to the connector part of the device.

The connector part may be a male connector part and the fluid container may be a female connector part, wherein the dose-measuring device is connected to the fluid container by introduction of the male connector part into the female connector part.

In an embodiment, the connector part has a first and second connection position relative to the fluid container, wherein in the first connection position the connector part is pre-assembled to the fluid container and fluid communication between fluid container and device is blocked, and wherein in the second connection position the connector part is connected to the fluid container and the fluid container is in fluid communication with the device, e.g. the chamber of the device.

The connector part may be configured to move between the first and second connection position by a relative translation with respect to the fluid container in longitudinal direction of the connector part.

Alternatively or additionally, the connector part may be configured to move between the first and second connection position by a relative rotation with respect to the fluid container about an axis parallel to a longitudinal direction of the connector part.

An embodiment provides a method for manufacturing a dose-measuring device, preferably a device according to the second aspect of the invention, adapted to be releasably received in a dispensing apparatus having an electromagnetic coil, comprising the following steps:
manufacturing a housing with an inlet passage and a connector part defining an inlet passage, said housing forming an internal chamber which is in fluid communication with the inlet passage and the outlet passage, and said connector part being connectable to a fluid container;
manufacturing a piston;
positioning a spring element into the inlet passage, i.e. the connector part;
assembling the piston and the housing such that the piston is moveably arranged in the chamber for reciprocating motion and is spring loaded by the spring element.

An embodiment provides a dispensing system comprising:
an electromagnetic coil;
a controller to drive the coil;
a dose-measuring device according to the first and/or second aspect of the invention, said device being receivable by the solenoid coil; and
a fluid container connected to the dose-measuring device.

An embodiment provides a method to place a combination of a fluid dose-measuring device, e.g. a device described herein, and a fluid container into a dispensing apparatus, said method comprising the following steps:
providing the combination of the fluid dose-measuring device and the fluid container, wherein the fluid dose-measuring device is connected to the fluid container such that the device is in a first connection position relative to the fluid container, and wherein in the first connection position fluid communication between fluid container and device is blocked, i.e. prevented;
putting the device in a second connection position relative to the fluid container, wherein in the second connection position the device is connected to the fluid container and the device is in fluid communication with the fluid container; and
introducing the combination of the device and the fluid container into the dispensing apparatus.

In an embodiment, the step of putting the device in a second connection position relative to the fluid container is automatically performed by the dispensing apparatus while introducing the combination of device and fluid container into the dispensing apparatus. This step is then not performed by the user or operator.

It is to be noted that the first and second connection position may be similar to the respective first and second connection position described in respect of the combination mentioned earlier.

As shown in FIGS. 1-8, a trigger 46 is provided, which when pressed signals the controller 80 to provide an intermittent current to the electromagnet 76 to initiate the dispensing of the stock liquid 12 from the cartridge 50. Referring to FIG. 1, stock liquid 12 dispensed from the cartridge 50 preferably enters a joining tube 17 fixed within the cartridge receiving area 31. At the same time, the controller opens the diluent control valve 18 to transfer liquid diluent 14 from the reservoir 22 through the diluent supply line 16 into the joining tube 17. A stream of diluent 14 is preferably dispensed generally into the discharge of the concentrate/extract 12 in close proximity to the pump body 54. In this manner, a uniform and substantially homogenous mixture of concentrate/extract 12 and diluent 14 exits the joining tube 17 into the dispensing area 30. This configuration is useful to prevent dispensing of poorly mixed concentrate/extract, known to those skilled in the art as “striping” or the “zebra effect”. Most preferably, the diluent 14 is dispensed generally perpendicular to the discharge of the concentrate/extract 12 as shown to increase mixing.

Preferably, the controller 80 continues to dispense diluent 14 for a short period of time after stopping the dispensing of the stock liquid 12 in order to clean the joining tube 17 of residual stock liquid 12. Alternatively, the joining tube 17 can be omitted, and the supply line 16 and the pump body 54 of the cartridge 50 are directed such that during dispensing, a stream of discharged stock liquid 12 enters a stream of discharged diluent 14 to promote mixing.

Referring to FIGS. 4-8, touch pad input controls 90, preferably including buttons 93 and switches 95, are provided to vary the strength of the beverage allowing a user to select a desired strength of the beverage. Visual indicators such as LEDs 92 indicate a selected beverage strength. Preferably, the buttons 93 are light pipes, as shown, for channeling light from the LEDs 92. Visual indicators such as LEDs 97a project light through light guides 99a to indicate the amount of stock liquid 12 remaining. Visual indicators such as LEDs 97b project light through light guides 99b to indicate the amount of diluent 14 remaining in the reservoir 22.

User input from the input controls 90 is used by the controller 80 to determine an amount of stock liquid 12 to be mixed with the diluent 14. This can be done by varying the speed by which the diluent 14 is dispensed by the control valve 18, and/or by controlling the electromagnet 76 to vary the rate at which the pump 41 pumps. Preferably, the diluent 14 is dispensed from the reservoir 22 by gravity, and the stock liquid 12 is dispensed from the cartridge 50 at a rate which is dependent on the selected beverage strength. The controller 80 preferably compensates for a decreasing reservoir diluent level (and the resultant decreasing diluent flow rate) by adjusting the rate at which the pump device 41 pumps. The adjustment of the pumping rate of the pump device 41 can occur several times, for example 8-10 times, during the dispensing of stock liquid 12 and diluent 14 into a single beverage container. Alternatively, the decreasing diluent level in the reservoir 22 can be compensated for during dispensing by opening the control valve 18 wider or through the use of a pump, and the stock liquid 12 can be dispensed from the cartridge 50 at a constant rate which is dependent only on the selected beverage strength.

Those skilled in the art will recognize that various numbers of different preset beverage strengths can be utilized and selected, for example through use of the input controls 90. Additionally, the beverage strength could be continuously variable, based on a user control with selected ranges shown as preferred for different types of beverages. Alternatively, a switch can be provided to allow a user to signal to the controller 80 which type of beverage is installed so that the controller 80 adjusts the amount of concentrate/extract 12 being dispensed accordingly. Various methods are known for identify the type of stock liquid 12 that is in the cartridge 50, such as an affixed ID. IDs that are automatically recognized by the controller 80 through different shape or different indicia located on the cartridge 50 are available, which can be read by a contact sensor 37 located in the receiving area 31 when the cartridge 50 is installed. The ID 61 on the cartridge could also include a radio frequency identification (RFID) tag which communicates with the sensor 37, having an RFID reader, positioned as shown or anywhere in the receiving area 31. In one embodiment, the ID 61 on the cartridge could include a barcode or computer readable symbols readable by a barcode reader or other visual-type reader positioned in the receiving area 31. Alternatively, the ID 61 could include an alignment pin for activating one of a plurality of switches to inform the controller 80 which type of beverage is installed. Alternatively, one or more functional components, for example the pump device 41, can be shaped and/or sized to indicate a beverage type, the shape and/or size of the functional component being able to be sensed by a sensor in the cartridge receiving area 31.

In addition, as shown in FIG. 2, a container ID 11, for example an RFID, can be provided on the container 19 to be read by a sensor 13, for example an RFID reader, in the dispensing area 30. The container ID 11 preferably includes a user's beverage strength preference information. The beverage strength information can be preprogrammed or programmed by the user through use of an ID writer 15, for example an RFID writer in the dispensing area 30, and using the input controls 90 to indicate a user's beverage strength preference.

The controller 80 preferably records an amount of pumping cycles performed by the pump device 41 to determine the amount of stock liquid 12 dispensed. Accordingly, the controller 80 signals the LEDs 97a to indicate an amount of stock liquid 12 remaining in the cartridge 50. Further, the controller 80 preferably uses information received from the stack pipe 88 to signal the LEDs 99a to indicate a level of diluent 14 remaining in the reservoir 22.

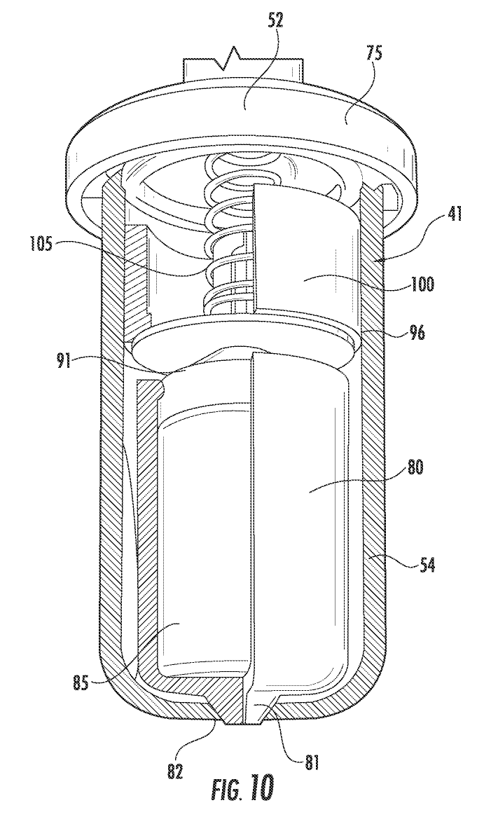

FIG. 13 shows an unassembled cartridge 450 including a pump device 441 and a hollow container 451. The male locking connector 452 preferably includes a conical head 452a and cross passages 452c. The locking connector 452 is connectable to a female mating connector 453 attached to the hollow body 451. The female mating connector 453 includes a plug 453a with a cavity 453b. The plug 453a is preferably removably or frangibly connected to a seat 453c located at an end of a bore 453e in a body 453f. In use, the male connector 452 is inserted into the bore 453e of the female connector 453 such that the conical head 452a of the male connector 452 enters the cavity 453b of the plug 453a. By inserting the male connector 452, the plug 453a is disconnected from the seat 453c allowing concentrate/extract 12 to flow from the hollow body 451, past flexible bodies 453d, through the cross passages 452c through the body of the connector 452 and into the pump body 454. The pump 41 and hollow body 51 may include the structures described in this paragraph for connection to one another as described in this paragraph for connection of pump device 441 to hollow container 451.

The dispenser 10 can be adapted to use the actuator 38 and use the cartridge 50 (or fluid dose-measuring device and fluid container) to dispense a variety of fluids including but not limited to hot coffee, hot tea, cold tea, hot chocolate, beverages of other flavors, baby formula, fluid condiments, fluid medicine, detergents, soaps, laundry or cleaning additives and endless other food and non-food products. Also, the dispenser 10, if desired, could dispense stock liquid into a container alone, without a diluent, for viscous fluids which do not require dilution. Further, the dispenser 10 could be incorporated into a multitude of other dispensing devices, for example, replaceable bottle office-style hot/cold water dispensers, and home and commercial refrigerators.

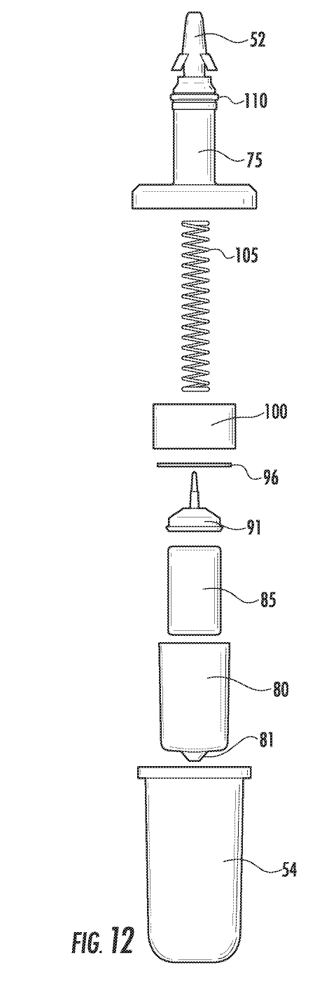

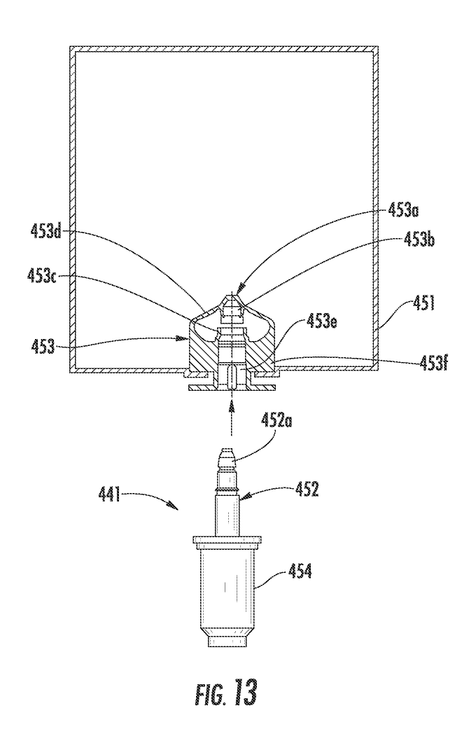

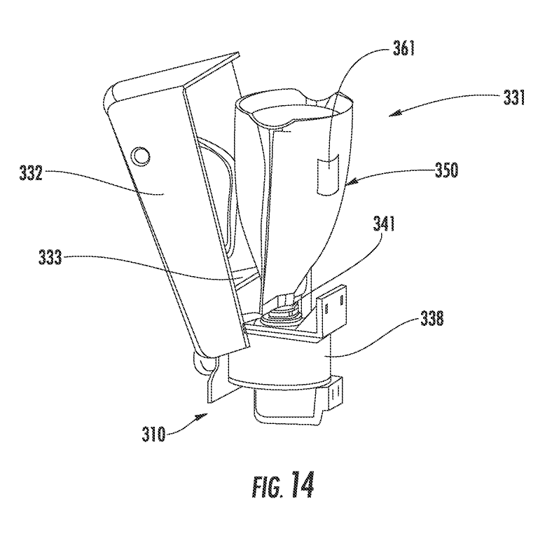

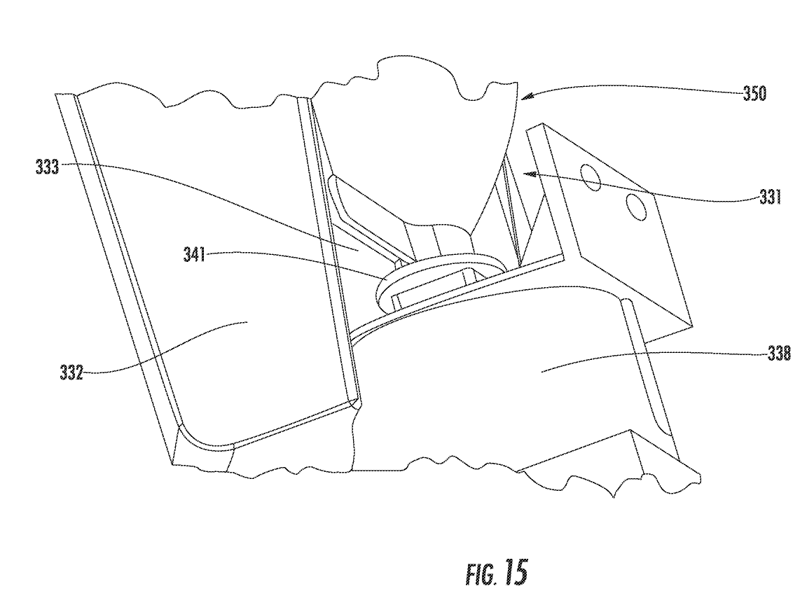

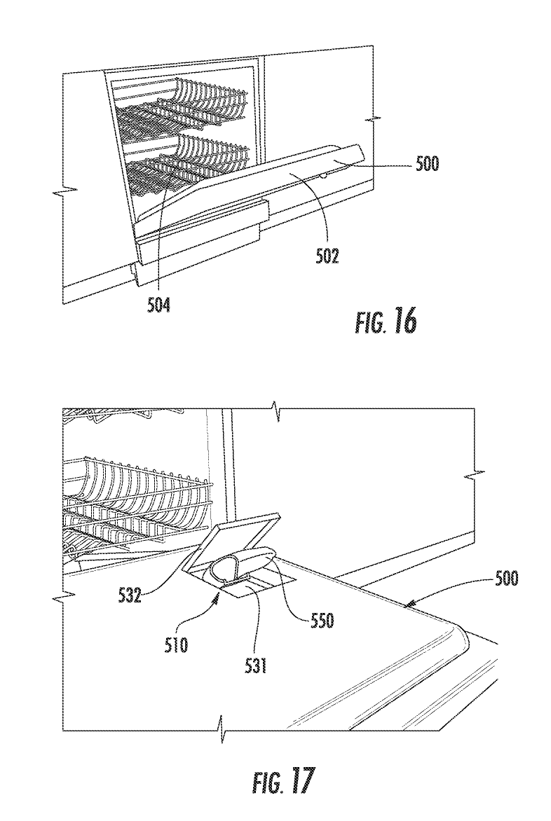

FIGS. 14 through 30 37b illustrate elements similar to those illustrated with respect to dispensers 10. For comparison, elements in FIGS. 14 to 30 retain the character reference number from previous descriptions of like elements in the tens and ones place, but add a hundreds place identifier. Any pump, cartridge, fluid dose-measuring device or fluid dose-measuring device and fluid container described, illustrated or claimed herein may be provided in any of the dispensers, appliances, carousels, or other machines described, illustrated or claimed herein. The term cartridge as used in reference to any dispenser, appliance, carousel or other machine herein refers to any cartridge or fluid dose-measuring device and fluid container described, illustrated or claimed herein.

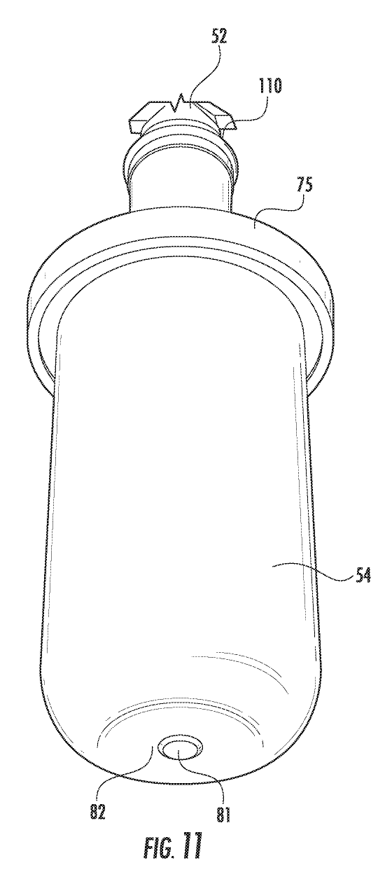

FIGS. 14 and 15 show a cartridge 350 with the pumping device 341 inserted in an accompanying cartridge receiving area 331 of a direct dispenser 310 in accordance with the sixth preferred embodiment of the present invention. This embodiment of the invention is capable of being installed into existing types of liquid mixing or dispensing systems to fulfill various regulated dispensing applications. In this embodiment, a loading door 332 is pivotably mounted to the dispenser 310 at a bottom portion of the loading door 332, similar to the loading door 32 described above. FIG. 15 shows the loading door 332 in an open position in which the concentrate/extract cartridge 350, preferably having an ID 361, can be loaded into the cartridge receiving area 331 with its pump device 341 being received in an actuator 338.

A separate controller or the controller of the existing equipment is provided to signal the actuator 338 with alternating or direct current in the same manner as discussed above in connection with the controller 80 to dispense liquid from the cartridge 350. FIG. 15 shows the door 332 in a closed position in which a retaining plate 333 rigidly attached to the door 332 contacts, or alternatively, resides in close proximity to a top portion of the pumping device 341 to retain the cartridge 350 in position. This configuration prevents the door from being closed when the concentrate/extract cartridge 350 is not properly positioned in the cartridge receiving area 331.

Referring to FIGS. 17-18, a dishwasher 500 according to an embodiment is shown. The dishwasher 500 includes a liquid detergent dispenser 510, similar to the direct dispenser 310, adapted to dispense metered amounts of liquid detergent 512 from a cleaning agent cartridge 550. The liquid detergent may be at strength or concentrated. Alternatively, the cleaning agent cartridge 550 can include other cleaning agents, for example anti-spotting agents. The cleaning agent cartridge 550 is similar to the stock cartridge 50 described above in the previous embodiments.

The dishwasher 500 includes a main door 502 for access to a dish containment area 504. The dispenser 510 is preferably located in the main door 502, and includes a dispenser door 532 which opens into a cartridge receiving area 531 having an actuator 538 similar to the actuator 38 described above. Alternatively, the dispenser 510 could be located in another position in the dishwasher 500, or could allow insertion from outside the dishwasher door 502. The cleaning agent cartridge 550, when loaded into the receiving area 531, is controlled by the actuator 538 to dispense liquid detergent 512 or another suitable cleaning agent into the dish containment area 504 during a wash cycle of the dishwasher 500. A controller 580 may control an amount of liquid detergent 512 dispensed by the actuator 538, as well as timing of the dispensing, depending on a type of selected wash cycle. This can also be adjusted based on a sensor detecting the cleanliness of the articles that are washed so that additional detergent could be dispensed if needed.

Referring to FIGS. 19-21, a clothes washer 600 according to an eighth embodiment of the present invention is shown. The clothes washer 600 includes a liquid laundry chemical dispenser 610, similar to the direct dispenser 310, adapted to dispense metered amounts of concentrated laundry chemicals 612 from laundry chemical cartridges 650. The laundry chemicals may be at strength or concentrated. The laundry chemicals 612 can include detergent, fabric softener, bleach, water conditioner or any suitable laundry product. The laundry chemical cartridges 650 are similar to the cartridges described above in the previous embodiments.

The clothes washer 600 includes a main door 602 for access to a wash area 604. The dispenser 610 includes a loading door 632 which opens into a cartridge receiving area 631 having a plurality of actuators 638, each similar to the actuator 38, 138 described above in the first preferred embodiment, positioned therein. Each of the actuators 638 is adapted to control one of the cartridges 650, which are removably positioned in the receiving area 631. Alternatively, a single actuator 638 can be provided, and the cartridges 650 can be selectively positioned in proximity to the single actuator 638, for example using a mechanism such as the carousel 902 describes below. The laundry chemical cartridges 650, when loaded in the receiving area 631, are selectively controlled by the actuators 638 to dispense laundry chemicals 612 into the wash area 604 during a wash cycle of the clothes washer 600. Preferably, a controller 680 controls an amount of laundry chemicals 612 dispensed by the actuators 638, as well as timing of the dispensing, depending on a selected wash cycle. Additionally, sensors can be provided to determine the level of cleanliness during washing, and additional detergent can be added, as required, by the controller 680.

A carousel with two or more cartridges such as described above for carousel 902 could be included in any appliance, commercial dispenser, or commercial beverage dispenser, including the others described herein.

An ID 661 is preferably provided on each of the cartridges 650 to indicate what type of laundry chemical 612 is in each of the cartridges 650. The controller 680 preferably uses the information contained by the IDs 661 as well as information received by user inputs entered on a control panel 690 to dispense laundry chemicals 612 in appropriate amounts at appropriate times during a wash cycle. Preferably, the controller 680 determines the amount of laundry chemical 612 dispensed from each cartridge 650 by counting a number of cycles of the actuator 638 and signals the control panel 690 to notify a user when one or more of the cartridges 650 are nearly empty.

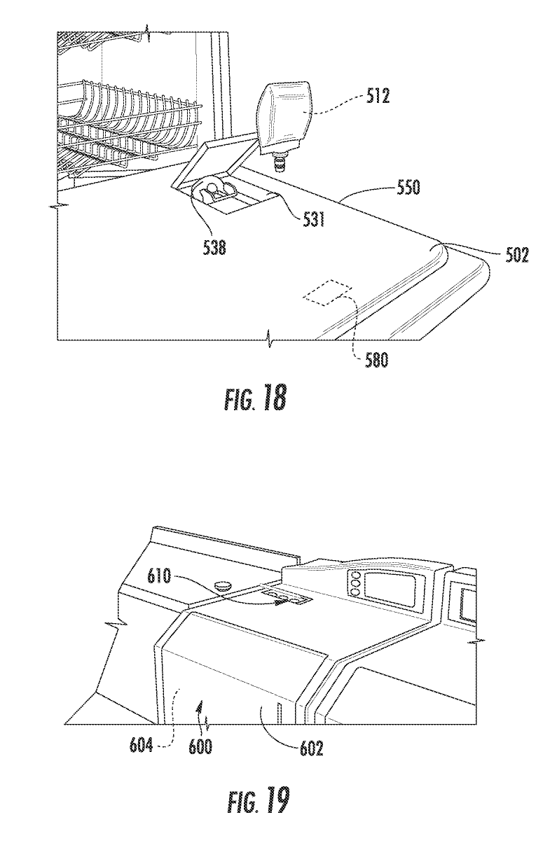

Referring to FIGS. 22 and 23, a medicine dispenser 710 according to an embodiment of the present invention is shown. The medicine dispenser 710 is similar to the dispense 310 and is adapted to dispense metered amounts of liquid medicine 712 from a medicine cartridge 750. The medicine 712 can include prescription or over-the-counter type medications for treating a variety of ailments. The medicine cartridge 750 is similar to the cartridges described above in the previous embodiments.

The dispenser 710 includes a receiving area 731 having an actuator 738 similar to the actuator 38 described above. The medicine cartridge 750, when loaded in the receiving area 731, is controlled by the actuator 738 to dispense liquid medicine 712 into a container receiving area 730 where a medicine dosing container 719 receives the dispensed medicine 712.

A controller 780 may control an amount of medicine 712 dispensed by the actuator 738. A unique ID 761 is preferably provided on each the cartridges 750 to indicate what type of medicine 712 is in the cartridge 750. Preferably, the ID 761 contains data which instructs the controller 780 to prompt a user with a display 792 to enter personal information using buttons 793 on a control panel 790. Entered personal information can include a user's age, weight, and height. The ID 761 can also contain data which instructs the controller 780 to prompt the user to enter information concerning the user's allergies or other drugs being taken by the user, to allow the controller to warn the user of potential side effects and adverse drug interactions. The controller 780 preferably uses a user's personal information along with information contained by the ID 761 to dispense an appropriate amount of medicine 712.

The controller 780 preferably determines the amount of medicine 712 dispensed from the cartridge 750 by counting a number of cycles of the actuator 738 and signals the control panel to notify a user when the cartridge 750 is nearly empty. The controller 780 can store in a memory information regarding the amount of medicine left in a plurality of different cartridges 750, associating each of the cartridges 750 with its unique ID 761, so the cartridges 750 can be rotated in and out of the dispenser 710 without affecting the stored memory.

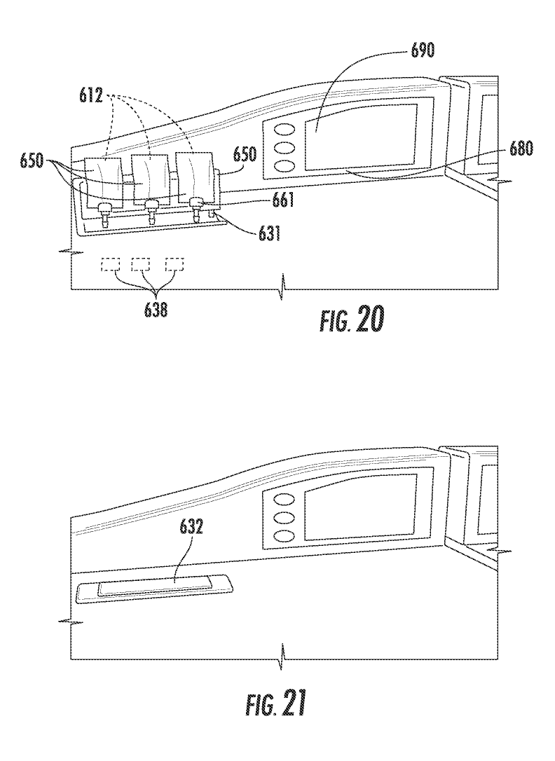

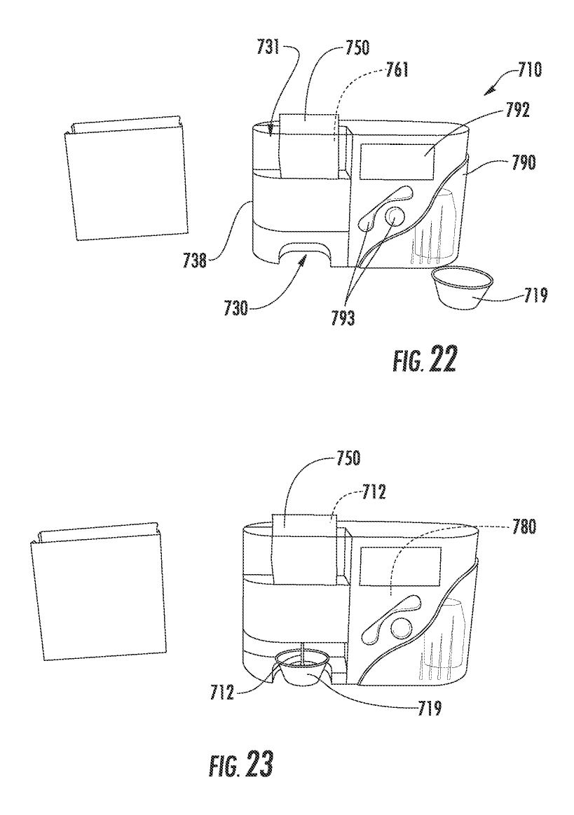

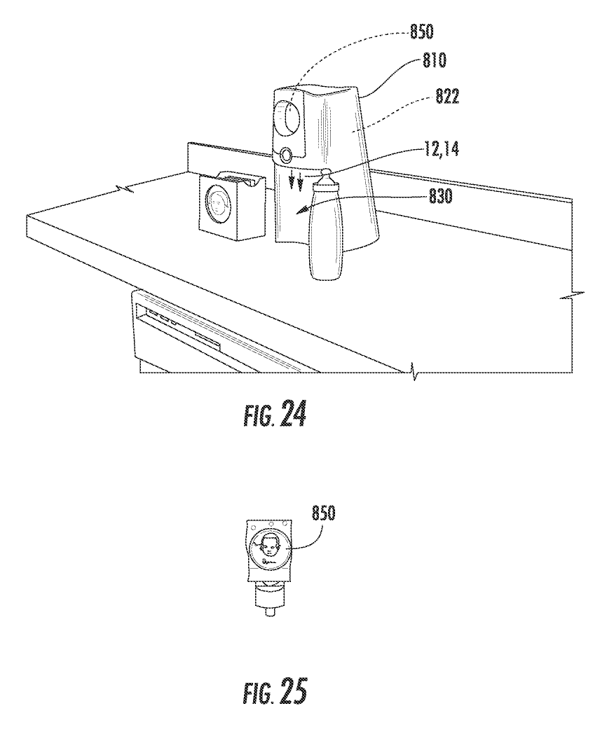

Referring to FIGS. 24 and 25, a liquid dispenser 810 adapted to dispense a mixture comprising a baby formula liquid concentrate/extract (designated by arrows 12 in a dispensing area 830) and a diluent (in a reservoir 822 and designated by arrows 14) according to an embodiment is illustrated. The dispenser 810 functions in a manner similar to the dispenser 10 described above. The dispenser 810 utilizes a concentrate/extract cartridge 850 which is preferably similar to the cartridges described above. Preferably, the dispenser 810 includes a user programmable temperature control for the diluent, so that baby formula is dispensed at a desired temperature, as well as at a desired predetermined strength.

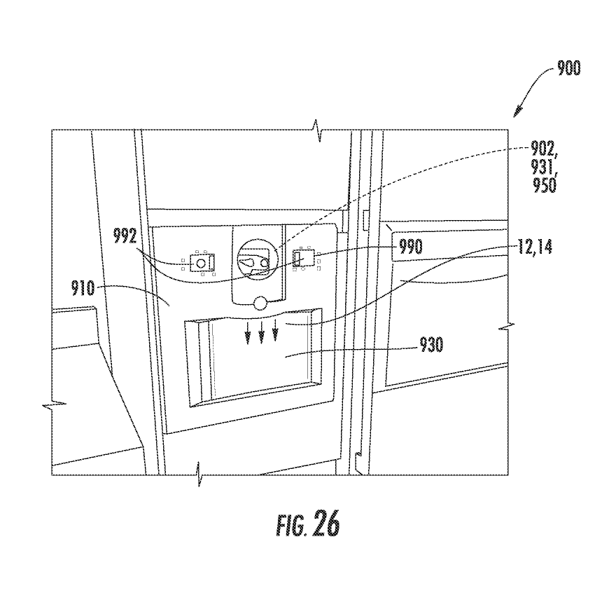

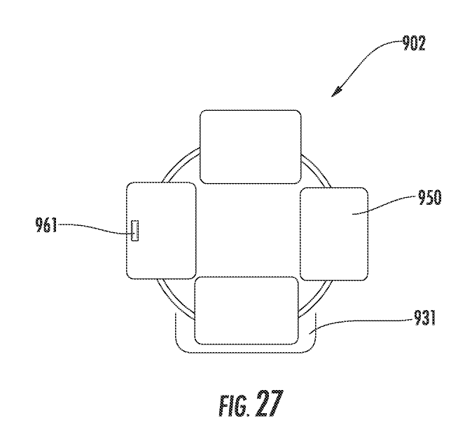

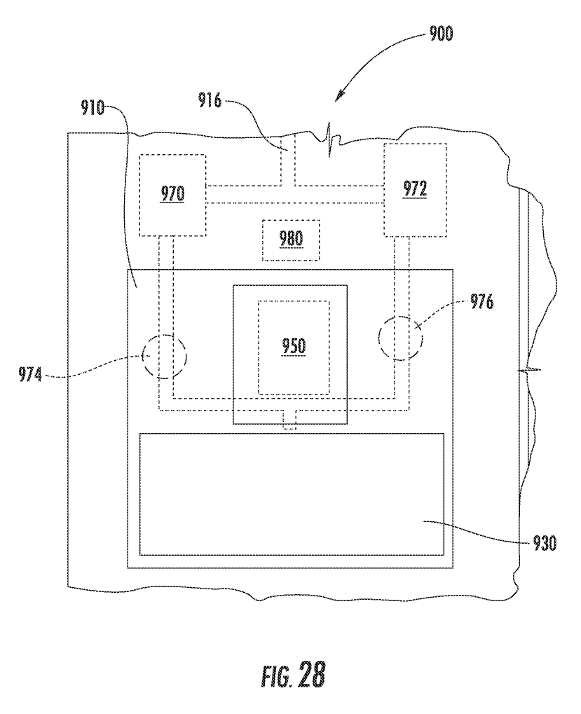

Referring to FIGS. 26 and 28, a home appliance, preferably a refrigerator 900, according to an embodiment is shown. The refrigerator 900 includes a beverage dispenser 910 adapted to dispense a beverage comprising a stock liquid (designated by arrows 12 in a dispensing area 930) and a diluent (designated by arrows 14). The dispenser 910 functions in a manner similar to the above discussed dispenser 10 and utilizes a stock liquid cartridge 950 which is preferably similar to the stock liquid cartridge 50. The refrigerator 900 preferably includes a supply line 916 connected to a home water line for providing a source of diluent 14, such as cold water, to the dispenser 910. Preferably, the supply line 916 preferably extends through a chiller 970, and a heater 972 can optionally be provided. Valves 974, 976 therefore allow a user to selectively dispense hot or cold diluent 14 to the dispensing area 330 based on inputs from a controller 980. In an alternative embodiment, the beverage dispenser 910 could dispense a stock liquid directly into a container without a diluent.

The dispenser 910 can also include a cartridge carousel 902, as shown in FIG. 27, for storing multiple cartridges 950, and selectively rotating the cartridges 950 in and out of a cartridge receiving area 931 where stock liquid cartridges 950 can be dispensed. User input controls 390, are provided to signal the controller 980 to rotate the carousel 902 to dispense a concentrate or extract from a desired one of the cartridges 950. Controls 990 are also preferably used to vary the strength of the beverage and to choose whether hot or cold diluent 14 is to be mixed with the concentrate/extract 12 from the chosen cartridge 950. Input controls 990 are preferably used to enter preferred beverage properties when a particular one of the cartridges 950 is first loaded onto the carousel 902, such that the controller 980 dispenses a beverage with preferred properties associated with the particular cartridge 950 each time that the particular cartridge 950 is selected and positioned in the receiving area 931 by the carousel 902. Preferably, an ID 961 is provided on each of the cartridges 950 to indicate the type of beverage stock liquid 12 that is in each of the cartridges 950. The controller 980 preferably uses the information contained by the ID 961 as well as information received by user inputs to dispense stock liquid 12 and hot or cold diluent 14 in appropriate proportions. Visual indicators such as digital displays 992 indicate a selected beverage type and/or selected beverage preferences.

Referring to FIGS. 29-30, a bottle-fed beverage dispenser 1010 according to an embodiment is shown. The dispenser 1010 is adapted to dispense a beverage comprising a liquid concentrate/extract (designated by arrows 12 in a dispensing area 1030) and a diluent (designated by arrows 14). The dispenser 1010 functions in a manner similar to the dispenser 10 and utilizes a stock liquid cartridge 1050 which is preferably similar to the stock liquid cartridges discussed above. A supply of diluent 14 is held in a replaceable bottle 1022 of the type typically used in known bottle-fed water dispensers.

The above described preferred embodiments of the present invention include a number of functional advantages over many of the known dispensing systems. The stock liquid cartridges allow the dispensing of precise amounts of liquid with consistent and reproducible results. The cartridges may include inexpensive components which allow them to be disposable in certain applications. The dispensers 10, 310, 510, 610, 710, 810, 910 and 1010 can be adapted to hold and dispense a variety of fluids besides those mentioned.

A diluent may be any type of liquid. Examples of a diluent include but are not limited to water, carbonated diluent, carbonated water, a pre-mixed multicomponent liquids, and a dairy products. The dispenser may dispense stock liquid directly onto or into non-liquid substances. The non-liquid substances may be but are not limited to a solid, semi-solid, or powder product. A non-liquid substance may be ice-cream, a powdered drink mix, or a frozen or semifrozen product (e.g., ice or slushed ice to make a frozen slushed ice or iced drink such as but not limited to a frozen daiquiri).

The appliances of embodiments herein are not limited to food products. Appliances for embodiments herein may include other consumables such as industrial, medical, pharmaceutical, or house-hold chemicals.

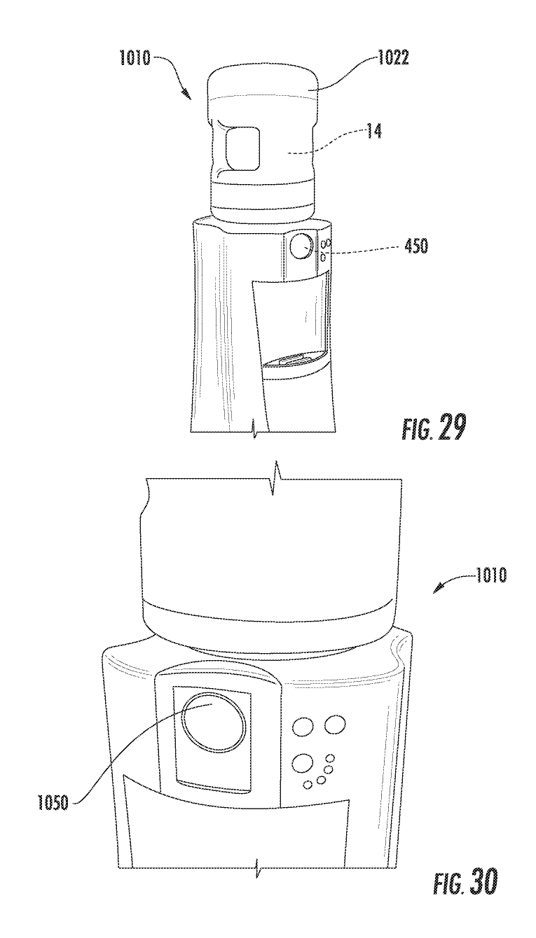

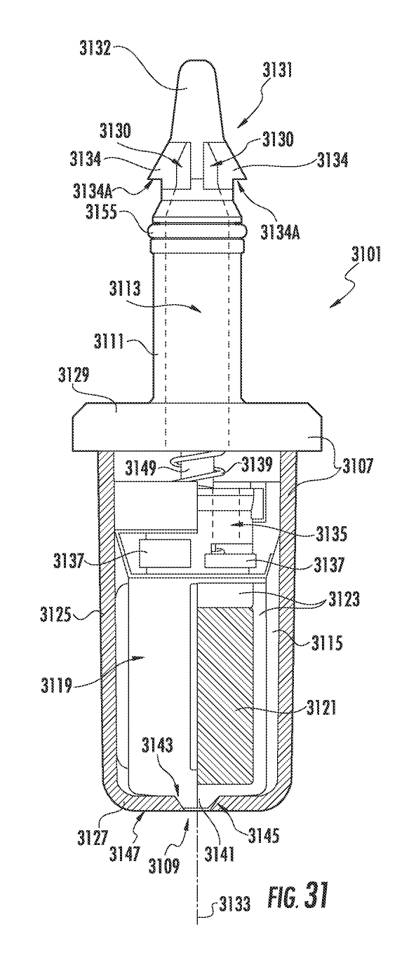

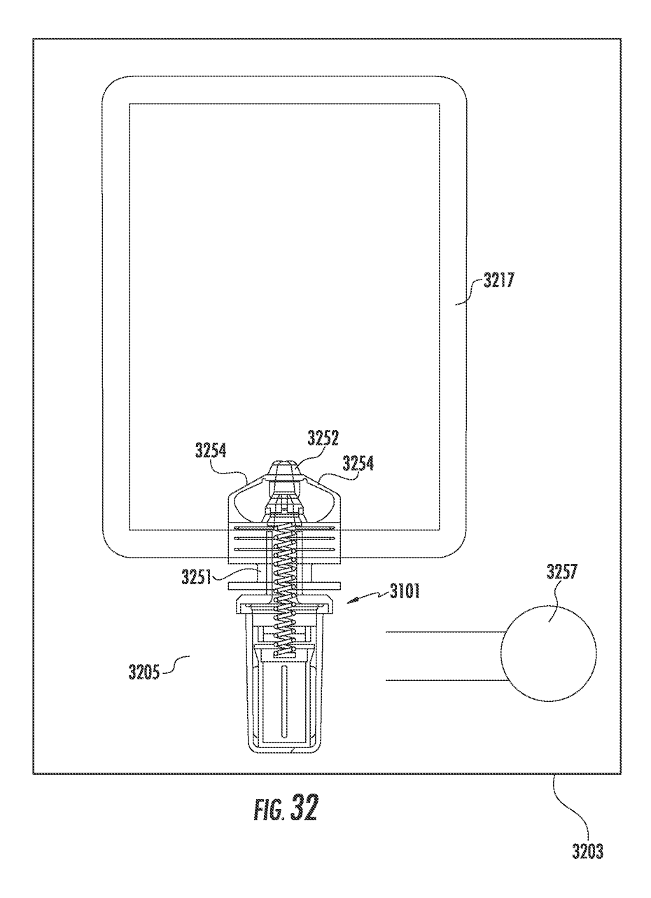

FIG. 31 shows a fluid dose-measuring device 3101 according to an embodiment of the invention in partial cut-away view. The device 3101 is adapted to be releasably received in a dispensing apparatus 3203 (see FIG. 32) having an electromagnetic coil 3205.

The device 3101 comprises a housing 3107 (see FIG. 31) with an outlet passage 3109 and a connector part 3111 defining an inlet passage 3113 which is depicted with dashed lines. The housing 3107 forms an internal chamber 3115 which is in fluid communication with the inlet passage 3113 and the outlet passage 3109. The connector part 3111 is connectable to a fluid container 3217 (see FIG. 32). The fluid container 3217 can be a pouch or a bag.

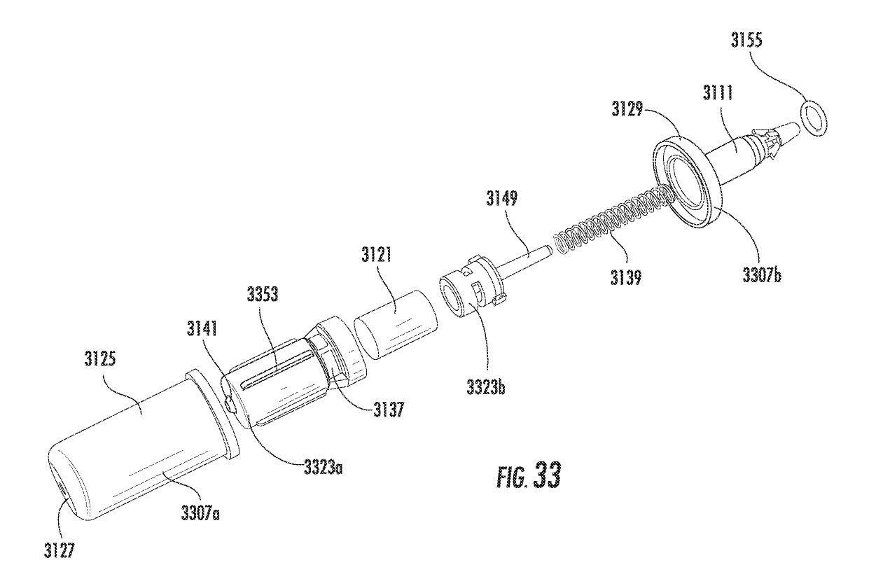

The device 3101 further comprises a piston 3119 (see FIG. 1) moveably arranged in the chamber 3115 of the housing 3107 for reciprocating motion between a closed position (as shown in FIG. 31) in which a flow from the inlet passage 3113 to the outlet passage 3109 is prevented and an open position (as shown in FIGS. 34B and 34C) in which a flow from the inlet passage to the outlet passage is allowed. The piston 3119 comprises a ferromagnetic actuation part 3121 for electromagnetic actuation of the piston 3119 by the electromagnetic coil 3205.

The actuation part 3121 is arranged in a separate outer body 3123 (see FIG. 31). The device also comprises a spring element 3139 tending to move the piston 3119 towards the closed position. The spring element 3139 extends from the piston into the inlet passage, i.e. into the connector part, as can be more clearly seen in FIGS. 32 and 34A-34D.

In this embodiment, the actuation part 3121 is encapsulated by the outer body 3123, thereby ensuring minimal contact between the fluid in the chamber 3115 and the actuation part 3121.

In FIG. 31 the piston is shown in the closed position, wherein the piston sealingly engages with the outlet passage 3109. This sealing engagement is provided by a protrusion 3141 having a sealing surface 3143, wherein the protrusion 3141 in the closed position extends into the outlet passage 3109. The sealing surface 3143 is in that case in engagement with a sealing surface 3145 of the outlet passage 3109. The respective sealing surfaces 3143, 3145 are defined by the surface areas that contact each other in the closed position. As can be seen in FIG. 31, sealing surface 3145 substantially extends to the outer surface 3147 of the housing, thereby minimizing the available space for fluid to remain in the outlet passage, resulting in less fluid being in contact with outside air and thus less chance of drying and clogging of the outlet passage.

The housing 3107 comprises a peripheral wall 3125, a bottom wall 3127, and a top wall 3129, wherein the outlet passage 3109 is situated in the bottom wall 3127, and wherein the connector part 3111 is attached to the top wall 3129 so that the inlet passage 3113 extends from the top wall to a free end 31 of the connector part.

The peripheral wall 3125 forms a tubular housing, wherein the inlet passage and the outlet passage are aligned with a longitudinal axis 3133 of the tubular housing.

The outer body 3123 has an internal passage 3135 depicted in dashed lines to allow fluid to flow from the inlet side of the piston to the outlet side of the piston. Integrated into the internal passage 3135 are non-return valves 3137, here in the form of flapper valves, but any kind of non-return valve may advantageously be employed. The non-return valves 3137 only allow fluid to flow from the inlet side of the piston to the outlet side of the piston. It is noted that in FIG. 31 the right valve 3137 is only partially shown due to the partial cut-away view. The left valve 3137 is shown entirely.

The flapper valves 3137 are moveable about a pivot axis (not shown) which may extend parallel to longitudinal axis 3133 or may extend in tangential direction of the piston. In case the pivot axis extends in tangential direction, the pivot axis is preferably provided at the inlet side of the flapper valve to allow a smooth flow profile with respect to a pivot axis at the outlet side of the flapper valve.

At the free end 3131 of the connector part 3111, the device comprises inlet ports 3130 through which fluid can enter the inlet passage 3113. The device further comprises a head 3132 which connects with a plug 3252 of a female connector part 3251 of the container 3217 (see FIG. 32). The plug 3252 is attached to the female connector part via flexible arms 3254. The device also comprises hooks 3134 which may be elastic and comprise a hooking surface 3134A which engages with a shoulder of a bore in the female connector part. The hooks may provide a permanent connection between connector part 3111 and female connector part 3251 after insertion of the connector part into the female connector part. By moving the device 3101 further into the female connector, the head 3132 of the device is able to lift the plug 3252 of its seat to allow fluid communication between the container and the device.

In FIG. 33 the device of FIG. 31 is shown in exploded view. From this FIG. 33 it can be clearly seen that the outer body 3123 is composed of two parts 3323a, 3323b, which in assembled state confine the actuation part 3121. The part 3323a has a cup shape with a cavity to receive the actuation part. On the outside of the part 3323a, ribs 3353 are provided. The ribs 3353 will make contact with the peripheral wall 3125 of the housing to guide the piston during reciprocating motion in the chamber. The non-return valves 3137 are integrally fabricated with the part 3323a.

The part 3323b comprises the internal passage 3135 and the seats for the non-return valves 3137 of the part 3323a. Fluid will therefore flow through the internal passage, pass the non-return valves and continue between the ribs 3353 on the outside of the part 3323a. When assembling the piston, the actuation part 3121 is positioned in the cavity of the part 3323a, after which the part 3323b closes the cavity like a plug.

The part 3323b further comprises a stem 3149 to be received in the inlet passage 3113. The spring element 3139 is placed over the stem 3149 so that the chance of buckling of the spring element is minimal.

At the free end 3131 of the connector part 3111, an O-ring 3155 is provided as a seal between the connector part 3111 and a female connector 3251 (see FIG. 32) in which the connector part 3111 is received.

From FIG. 33 it also follows that the housing 3107 is composed of two parts 3307a, 3307b. Part 3307a has a cup shape and comprises the peripheral wall 3125 and bottom wall 3127. Part 33017b comprises the top wall 3129 and extending from the top wall the connector part 3111. Part 3307a forms a cavity that is closed by part 3307b to form the internal chamber.

FIG. 32 shows a dispensing apparatus 3203 according to the invention, wherein a dose-measuring device 3101 is received in the electromagnetic coil 3205. The dose-measuring device is connected to the container 3217 by a female connector 3251 which receives the connector part 3111 of the device 3101. The connector part 3111 is thus a male connector part. The apparatus 3203 further comprises a controller 3257 to drive the electromagnetic coil 3205.

An example of driving the electromagnetic coil will be explained with reference to FIGS. 34A-34D. In FIG. 34A, the coil is deenergized and the piston is in the closed position. The coil is subsequently energized in an appropriate manner such that due to interaction between the generated electromagnetic field and the ferromagnetic material of the piston, the piston will move to an open position as indicated by arrow 3461 in FIG. 34A. Due to pressure of fluid in the container the non-return valves will open, i.e. in this case pivot about their respective pivot axes, to allow the piston to move through the fluid column in the chamber to the open position as indicated by FIG. 34B.

The electromagnetic coil is subsequently deenergized so that the piston is moved back to the closed position by the spring element 3139, indicated by arrow 3463 in FIG. 34C. Due to the fluid inside the chamber and associated pressure, the non-return valves will close, and while travelling to the closed position, the piston forces fluid out of the chamber through the outlet passage. At the same time, fluid is drawn out of the container into the chamber as indicated by arrow 3465 in FIG. 34C. A full reciprocating motion is reached once the piston is back in the closed position, as indicated in FIG. 34D. And a new cycle beginning at FIG. 34A can commence.

It is noted here that when multiple reciprocating motions are performed after each other, the piston does not necessarily has to reach the closed position in between two reciprocating motions. The reciprocating motions may also be performed between two open positions. The last reciprocating motion will however preferably end in the closed position to prevent leakage.

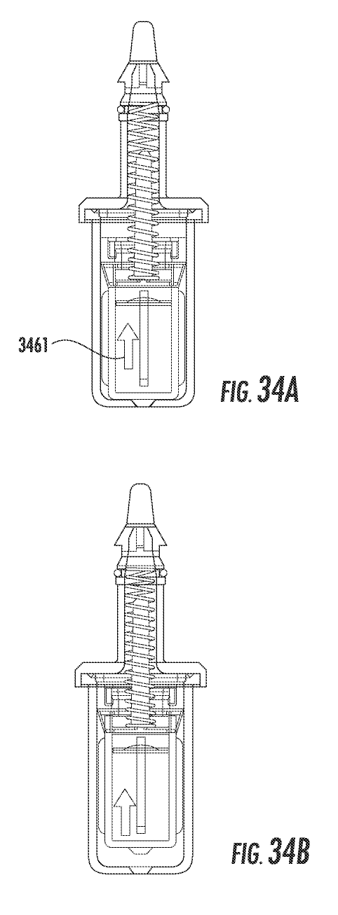

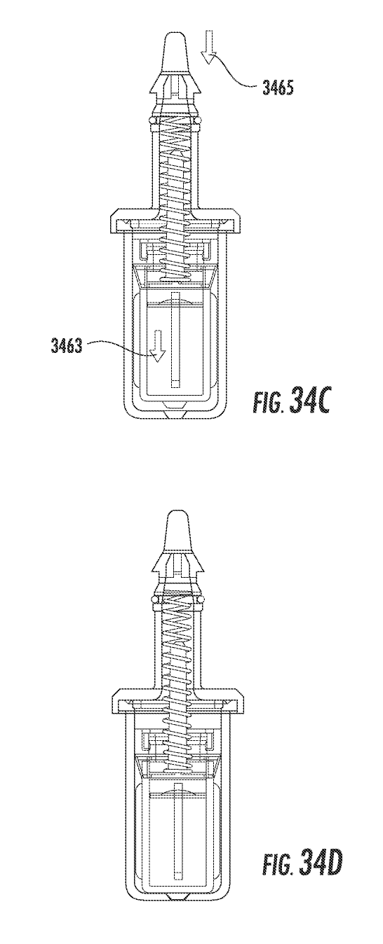

FIG. 35A shows schematically in combination a dose-measuring device 3101 according to an embodiment of the invention and a fluid container 3217. The device 3101 and fluid container are shown in disassembled state in FIG. 35A.

The device 3101 is similar to the dose-measuring device of FIG. 31 and comprises a connector part 3111. The connector part 3111 is a male connector part and has a external thread 3570 arranged at an outer surface of the connector part 3111.

The fluid container 3217 comprises a female connector part 3251 for receiving the connector part 3111. The female connector part 3251 has a body 3586 containing an axial bore which extends from an insert opening 3580 for the male connector part 3111 through the body, and a seat extending around the bore for a plug 3584 which serves to close off the bore. In FIG. 35A, the plug is shown in its seat. The bore has an internal thread 3582 which is configured to cooperate with the external thread of the device when the male connector part is inserted into the bore.

The plug 3584 is configured to connect with a head 3572 of the male connector part when the male connector part is inserted into the bore. The position in which the male connector part is connected to the plug of the female connector part, but the plug is in its seat and thus closes off the bore is referred to as the first connection position of the device 1 relative to fluid container 3217. This situation is shown in FIG. 35B. When the device is in the first connection position, the device is not in fluid communication with the fluid container, and thus contact between the content of the fluid container and air outside the fluid container, even the small amount of air present in the device is prevented.

When the combination of device and container is to be used in a dispensing apparatus, fluid communication between device and fluid container is obtained by a rotation of the device with respect to the fluid container, such that the cooperation between the internal thread and the external thread causes the device to be inserted more into the female connector part, so that the plug 84 is disengaged from its seat and no longer closes off the bore. This position of the device relative to the fluid container is referred to as the second connection position (see FIG. 35C). The rotation of the device is shown in FIG. 35B by arrow 3590 and the subsequent translation of the device is shown by arrow 3592. To go back from the second connection position in FIG. 35C to the first connection position in FIG. 35B, the device has to be rotated in an opposite direction. This opposite rotation is shown by arrow 3594 in FIG. 35C and the subsequent translation is shown by arrow 3596 in FIG. 35C.

The rotation of the device with respect to the fluid container can be carried out by a person placing the combination in a dispensing apparatus, preferably prior to placing the combination in the dispensing apparatus. However, the dispensing apparatus may alternatively or additionally be provided with actuators to rotate the device with respect to the fluid container after placing the combination in the dispensing apparatus.

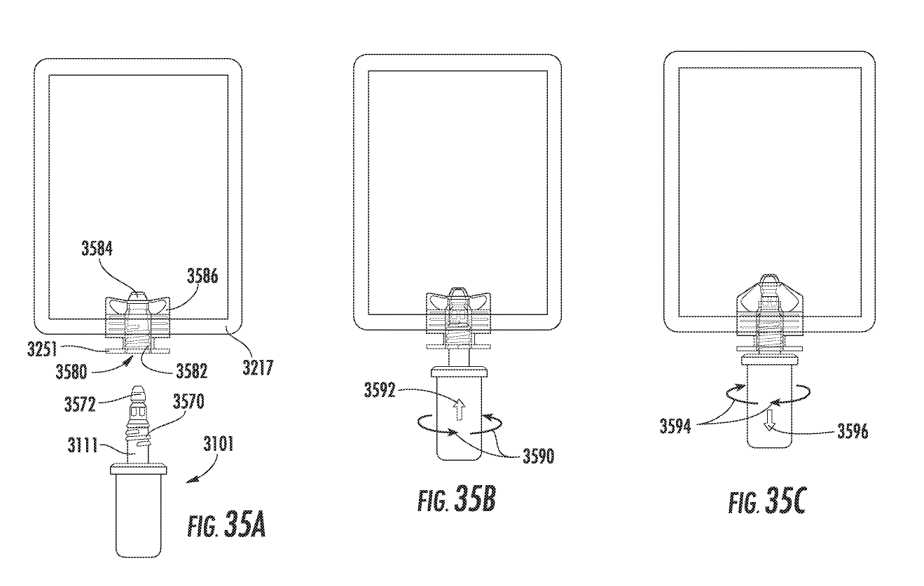

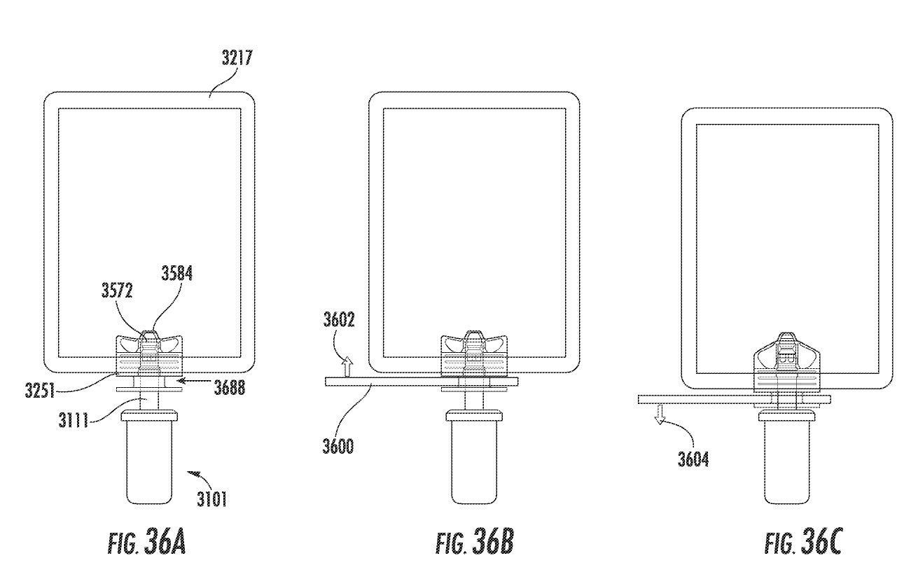

FIG. 36A shows schematically a dose-measuring device 3101 according to another embodiment of the invention and a fluid container 3217. The dose-measuring device 1 is similar to the devices shown in FIG. 3101 and FIG. 35A-35C, but has no external thread arranged at the outer surface of male connector part 3111.

The fluid container 3217 comprises a female connector part 3251 for receiving the male connector part of the device. The fluid container 3217 is similar to the fluid containers shown in FIG. 35A-35C, but has no internal thread in the bore of the female connector part.

The male connector part 3111 in FIG. 36A is inserted into the bore of the female connector part and a head 3572 of the male connector part connects with the plug 3584 of the female connector part. The plug 3584 in the position shown in FIG. 36A closes of the bore and thus prevents fluid communication between the fluid container and the device. This position is referred to as the first connection position.

The female connector part 3251 has a recess 3688 for receiving a lever arm 3600 of a dispensing apparatus (see FIG. 36B). When the device is in the first connection position, the content of the fluid container can not contact air outside the fluid container, not even the small amount of air in the device. In this situation, the combination will be transported to a dispensing apparatus. After placement, the lever arm 3600 will be received in the recess 3688 of the female connector part.

By pushing the lever arm 3600 downwards as indicated by the arrow 3604 in FIG. 36C, the device can be brought into a second connection position in which the plug is disconnected from its seat and fluid communication between the device and fluid container is allowed. Bringing the device back to its first connection position as shown in FIG. 36B can be done by pushing the lever arm 3600 upwards as indicated by arrow 3602. During the relative motion between the device and the fluid container as indicated by arrows 3602, 3604, the device has to be retained in its position. This can for instance be done by an electromagnetic coil in which the lower part of the device 3101, i.e. the part with the piston and actuation part, will be placed in. See for example FIG. 32.

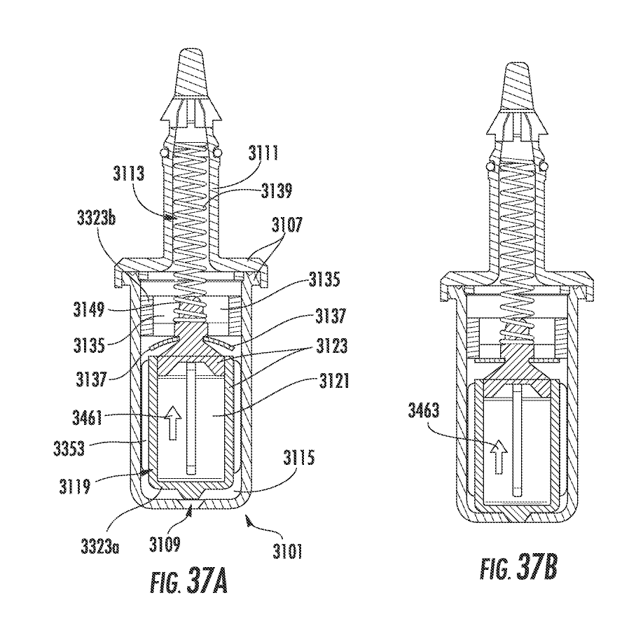

FIG. 37A shows a cross sectional view of a dose-measuring device 1 according to yet another embodiment of the invention. The device 3101 is adapted to be releasably received in a dispensing apparatus, for instance the dispensing apparatus according to FIG. 32.

The device 3101 comprises a housing 3107 with an outlet passage 3109 and a connector part 3111 defining an inlet passage 3113. The housing 3107 forms an internal chamber 3115 which is in fluid communication with the inlet passage 3113 and the outlet passage 3109. The connector part 3111 is connectable to a fluid container, for instance the fluid container of FIG. 33, 35 or 36.

The device 3101 further comprises a piston 3119 moveably arranged in the chamber 3115 of the housing 3107 for reciprocating motion between a closed position (similar to the position of the device 3101 in FIG. 31) in which a flow from the inlet passage 3113 to the outlet passage 3109 is prevented and an open position (as shown in FIGS. 37A and 37B) in which a flow from the inlet passage to the outlet passage is allowed. The piston 3119 comprises a ferromagnetic actuation part 3121 for electromagnetic actuation of the piston 3119 by an electromagnetic coil.

The actuation part 3121 is arranged in a separate outer body 3123. The device also comprises a spring element 3139 tending to move the piston 3119 towards the closed position. The spring element 3139 extends from the piston into the inlet passage, i.e. into the connector part.

In this embodiment, the actuation part is encapsulated by the outer body 3123, thereby ensuring minimal contact between the fluid in the chamber 3115 and the actuation part 3121.

The outer body 3123 has an internal passage 3135 to allow fluid to flow from the inlet side of the piston to the outlet side of the piston. Integrated into the internal passage are non-return valves 3137. In FIG. 37A, the valves 3137 are shown in an open position in which fluid flows from the inlet side of the piston to the outlet side of the piston. This is caused by the upward movement of the piston, i.e. in the direction of the inlet passage, indicated by the arrow 3461. In FIG. 37B, the valves 3137 are shown in a closed position so that fluid below the valves 3137, i.e. on the outlet side of the vales 3137, can be forced out of the device through the outlet passage by movement of the piston towards the closed position, as indicated by arrow 3463.

The working principle of the device 3101 is similar to the working principle of the device according to FIGS. 31 and 34A-34D. FIG. 37A thus corresponds to FIG. 34B and FIG. 37B corresponds to FIG. 34C.

The outer body 3123 is composed of two parts 3323a, 3323b, which in assembled state confine the actuation part 3121. The part 3323a has a cup shape with a cavity to receive the actuation part. On the outside of the part 3323a, ribs 3353 are provided to guide the piston during reciprocal motion.

The part 3323b comprises the internal passage 3135 and the non-return valves 3137. The part 3323b also acts as a plug to close of the cavity in part 3323a.

The part 3323b has a protrusion 3149 around which the spring element is provided. It is noted here that this protrusion is not extending into the connector part, but functions to hold one end of the spring element. The advantage of the protrusion not extending into the connector part is that the inlet passage is not restricted by the protrusion and thus, fluid is able to flow smoothly through the inlet passage.

In further embodiments, any one or more element from any embodiment herein may be combined with any other embodiment herein, or substituted for any one or more element from any other embodiment herein.

While the preferred embodiments of the invention have been described in detail above, the invention is not limited to the specific embodiments described which should be considered as merely exemplary. Further modifications and extensions of the present invention may be developed and all such modifications are deemed to be within the scope of the present invention as defined by the appended claims.

1. An appliance including a dispenser for a liquid, the appliance being selected from the group consisting of a drink maker, a coffee maker, a refrigerator, a water cooler, a dish washer, a washing machine, a baby formula dispenser or a medicine dispenser, comprising:
a housing including a dispensing area for dispensing a fluid;
a cartridge receiving area in the housing;
an electromagnetic dispensing actuator located in the housing;
a cartridge removably insertable into the cartridge receiving area in a position to be actuated by the electromagnetic dispensing actuator, the cartridge adapted to hold a stock liquid to be dispensed into the dispensing area after placement into the cartridge receiving area, the cartridge comprising:
a hollow body adapted to contain the stock liquid;
a pump having a connector attached to a pump body, the pump body connected to the hollow body through the connector, the pump further including a plunger inside the pump body, a valve seat disposed between the connector and the plunger, and a valve disposed between the valve seat and the plunger, a metal body including a ferromagnetic material located in the plunger, and an orifice in the pump body; and
a controller located in the housing to control the electromagnetic dispensing actuator to discharge stock liquid from the cartridge.

2. The appliance of claim 1, further comprising a diluent supply line connected to at least one of a diluent pump and a control valve for delivering a stream of diluent with the stock liquid, wherein the orifice of the pump body is positioned to deliver a stream of the stock liquid into the stream of the diluent.

3. The appliance of claim 2, further comprising a joining tube connected to the diluent supply line and removably connected to the pump body of the cartridge, wherein the diluent supply line is positioned to deliver a stream of diluent into the joining tube generally perpendicular to a stream of the stock liquid delivered into the joining tube by the pump body.

4. The appliance of claim 1, wherein the electromagnetic dispensing actuator comprises;
a wound coil for producing a magnetic flux;
a focusing ring made of a ferromagnetic material connected to the coil in proximity to the pump body; and
a pole piece made of a ferromagnetic material connected to the coil in proximity to the pump body spaced from the focusing ring.

5. The appliance of claim 1, wherein the dispensing actuator includes an aperture for removably receiving the pump of the cartridge, and the appliance further comprises a loading door which includes a retaining plate, the loading door being pivotably attached to the housing, wherein in a closed position of the loading door, the retaining plate holds the pump within the aperture in the actuator to retain cartridge in the housing, and wherein in an open position of the loading door, the cartridge is removable from the housing.

6. The appliance of claim 1, wherein the appliance is the refrigerator or the water cooler, the orifice is directed toward a water outlet, and the controller controls the electromagnetic dispensing actuator such that the stock liquid from the cartridge is dispensed as the water is dispensed from the appliance.

7. The appliance of claim 6, wherein the controller controls other appliance functions.

8. The appliance of claim 1, wherein the appliance is the dish washer or the washing machine, and the controller controls the washing cycle and dispensing of a predetermined or programmable amount of the stock liquid from the cartridge in accordance with a predetermined time in the washing cycle.

9. The appliance of claim 1, wherein the appliance is the baby formula dispenser, and the controller controls an amount of the stock liquid being dispensed from the cartridge and a temperature of baby formula dispensed

10. The appliance of claim 1, wherein the appliance is a medicine dispenser, and the controller controls an amount of medicine dispensed based on input parameters.

11. The appliance of claim 1, wherein the metal body is surrounded by a non-metal material.

12. The appliance of claim 1, wherein one or more portions of the cartridge are made of a non-metal material or are coated with a non-metal material on a surface that contacts the stock liquid.

13-16. (canceled)

17. A fluid dose-measuring device adapted to be releasably received in a dispensing apparatus having an electromagnetic coil, comprising:
a housing with an outlet passage and a connector part defining an inlet passage, said housing forming an internal chamber which is in fluid communication with the inlet passage and the outlet passage, and said connector part being connectable to a fluid container;
a piston moveably arranged in the chamber of the housing for reciprocating motion between a closed position in which a flow from the inlet passage to the outlet passage is prevented and an open position in which a flow from the inlet passage to the outlet passage is allowed, said piston comprising a ferromagnetic actuation part for electromagnetic actuation of the piston by the electromagnetic coil, wherein said actuation part is arranged in an outer body.

18. A fluid dose-measuring device according to claim 17, wherein the actuation part is encapsulated by the outer body.

19. A fluid dose-measuring device according to claim 17, wherein the piston in the closed position sealingly engages with the outlet passage.

20. (canceled)

21. A fluid dose-measuring device according to claim 17, wherein the housing comprises a peripheral wall, a bottom wall, and a top wall, said outlet passage being situated in the bottom wall, and said connector part being attached to the top wall, wherein the inlet passage extends from the top wall to a free end of the connector part.

22. A fluid dose-measuring device according to claim 21, wherein the peripheral wall forms a tubular housing, and wherein the inlet passage and outlet passage are aligned with a longitudinal axis of the tubular housing.

23. A fluid dose-measuring device according to claim 17, wherein the outer body has an internal passage to allow fluid to flow from the inlet side of the piston to the outlet side of the piston.

24. A fluid dose-measuring device according to claim 23, wherein the outer body has one or more valves in the internal passage for allowing a fluid flow only from the inlet side of the piston to the outlet side of the piston.

25. A fluid dose-measuring device according to claim 17, wherein the outer body of the piston is composed of two parts, which in an assembled state retain the actuation part.

26. A fluid dose-measuring device according to claim 25, wherein one outer body part has a cup shape with a cavity to receive the actuation part, and wherein the other outer body part is configured to close off the cavity.

27-28. (canceled)

29. A fluid dose-measuring device according to claim 17, wherein the piston is spring loaded by a spring element tending to move the piston towards the closed position.

30. A fluid dose-measuring device according to claim 17, wherein the outer body comprises a protrusion to sealingly engage with the outlet passage in the closed position.

31-34. (canceled)

35. A fluid dose-measuring device according to claim 29, wherein the piston comprises a stem extending into the inlet passage, and wherein the spring element is provided around the stem.

36. A combination comprising a fluid dose-measuring device according to claim 17 and a fluid container connectable or connected to the connector part.

37. The combination according to claim 36, wherein the connector part is a male connector part and the fluid container comprises a female connector part, and wherein the dose-measuring device is connected to the fluid container by introduction of the male connector part into the female connector part.

38-40. (canceled)

41. A method for fabricating a dose-measuring device adapted to be releasably received in a dispensing apparatus having an electromagnetic coil, comprising the following steps:
manufacturing a housing with an inlet passage and a connector part defining an inlet passage, said housing forming an internal chamber which is in fluid communication with the inlet passage and the outlet passage, and said connector part being connectable to a fluid container;
manufacturing a ferromagnetic actuation part;
manufacturing an outer body;
assembling the actuation part and the outer body to form a piston, such that the actuation part is arranged in the outer body;
assembling the piston and the housing, such that the piston is moveably arranged in the chamber for reciprocating motion.

42-43. (canceled)

44. A dispensing system comprising:
an electromagnetic coil;
a controller to drive the electromagnetic coil;
a fluid dose-measuring device according to claim 17 receivable by the electromagnetic coil; and
a fluid container connected to the dose-measuring device.

45. The appliance of claim 7, wherein the controller controls temperature.

46. A fluid dose-measuring device according to claim 25, wherein the two parts encapsulate the actuation part in the assembled state.
